(19) United States
(12) Patent Application Publication
(10) Pub. No.: US 2024/0340395 A1
(43) Pub. Date: Oct. 10, 2024

(54) IMAGE PROCESSING APPARATUS AND IMAGE PROCESSING METHOD

(71) Applicant: Sony Group Corporation, Tokyo (JP)

(72) Inventor: Kenji KONDO, Tokyo (JP)

(73) Assignee: Sony Group Corporation, Tokyo (JP)

(21) Appl. No.: 18/716,327

(22) PCT Filed: Dec. 28, 2022
(86) PCT No.: PCT/JP2022/048482

§ 371 Date: Jun. 4, 2024

Related U.S. Application Data
(60) Provisional application No. 63/294,549, filed on Dec. 29, 2021.

(51) Int. Cl. H04N 9/64; G06T 3/40; H04N 19/105; H04N 19/136; H04N 19/172; H04N 19/186; H04N 19/463; H04N 19/503

(52) U.S. Cl. CPC H04N 9/64; G06T 3/40; H04N 19/105; H04N 19/136; H04N 19/172; H04N 19/186; H04N 19/463; H04N 19/503

(57) ABSTRACT

There is provided an image processing apparatus and an image processing method capable of reducing deterioration of a chrominance component in resolution reduction. A conversion unit performs reduction processing of reducing resolution of at least a luminance component of an image including the luminance component and two chrominance components to convert a chroma format of the image, and the encoding unit encodes the image in which the chroma format has been converted to generate a bitstream. The present technology can be applied to, for example, an image encoding apparatus and an image decoding apparatus.

### TECHNICAL FIELD

The present disclosure relates to an image processing apparatus and an image processing method, and more particularly, to an image processing apparatus and an image processing method capable of reducing deterioration of a chrominance component in resolution reduction.

### BACKGROUND ART

Conventionally, an apparatus that compresses and encodes an image by employing an encoding scheme that treats image information as digital, and at that time, compresses the image by orthogonal transform such as discrete cosine transform and motion compensation using redundancy specific to the image information for the purpose of transmitting and accumulating information with high efficiency has been spreading.

Examples of the encoding method include moving picture experts group (MPEG), H.264 and MPEG-4 Part 10 (advanced video coding, hereinafter referred to as H.264/AVC), and H.265 and MPEG-H Part 2 (high efficiency video coding, hereinafter referred to as H.265/HEVC).

In addition, in order to further improve encoding efficiency for advanced video coding (AVC), high efficiency video coding (HEVC), and the like, standardization of a coding scheme called versatile video coding (VVC) is in progress (see support of embodiments to be described later).

Non-Patent Document 1 discloses reference picture resampling (RPR), which is one of the functions of VVC.

### CITATION LIST

### Non-Patent Document

Non-Patent Document 1: Recommendation ITU-T H.266 (August 2020) “Versatile video coding”

### SUMMARY OF THE INVENTION

### Problems to be Solved by the Invention

Conventionally, as the resolution of an image (a moving image which is an aggregate of images) is reduced by encoding at a low bit rate, the degradation of encoding of a chrominance component (chroma component) may increase. For example, in a case where a certain image is to be encoded at a low bit rate, the transmission efficiency in image quality and bit rate is often higher when the size is reduced by reducing the resolution of the original image.

The present disclosure has been made in view of such a situation, and an object of the present disclosure is to reduce degradation of chrominance component in resolution reduction.

### Solutions to Problems

An image processing apparatus according to a first aspect of the present disclosure includes: a conversion unit that performs reduction processing of reducing resolution of at least a luminance component of an image including the luminance component and two chrominance components to convert a chroma format of the image; and an encoding unit that encodes the image in which the chroma format has been converted to generate a bitstream.

An image processing method according to a first aspect of the present disclosure includes: by an image processing apparatus, performing reduction processing of reducing resolution of at least a luminance component of an image including the luminance component and two chrominance components to convert a chroma format of the image; and encoding the image in which the chroma format has been converted to generate a bitstream.

In the first aspect of the present disclosure, reduction processing of reducing resolution of at least a luminance component of an image including the luminance component and two chrominance components is applied, a chroma format of the image is converted, and the image in which the chroma format has been converted is encoded to generate a bitstream.

An image processing apparatus according to a second aspect of the present disclosure includes: a decoding unit that decodes a bitstream to generate an image including one luminance component and two chrominance components; and a conversion unit that converts a chroma format of the image by performing enlargement processing of enlarging resolution of at least the luminance component of the image generated by the decoding unit.

An image processing method according to a second aspect of the present disclosure includes: by an image processing apparatus, decoding a bitstream to generate an image including one luminance component and two chrominance components; and converting a chroma format of the image by performing enlargement processing of enlarging resolution of at least the luminance component of the image generated.

In the second aspect of the present disclosure, a bitstream is decoded to generate an image including one luminance component and two chrominance components, and enlargement processing of enlarging resolution of at least the luminance component of the image generated is performed to convert a chroma format of the image.

### BRIEF DESCRIPTION OF DRAWINGS

FIG. 1 is a diagram illustrating an example of an image (YUV 4:2:0).

FIG. 2 is a diagram illustrating an example in which the image of FIG. 1 is displayed by being divided into a luminance component Y, a chrominance component U, and a chrominance component V.

FIG. 3 is a diagram for explaining an example of processing of reducing and encoding an image.

FIG. 4 is a diagram for explaining an example of processing of enlarging a decoded image.

FIG. 5 is a diagram for explaining an example of processing in which the reference frame is 1080p 4:2:0 and the current frame is 720p 4:2:0.

FIG. 6 is a diagram for explaining an example of processing in which the reference frame is 720p 4:2:0 and the current frame is 1080p 4:2:0.

FIG. 7 is a diagram for explaining an example of processing of reducing resolution only for a luminance component and performing encoding.

FIG. 8 is a diagram for explaining an example of processing of enlarging resolution only for a luminance component of a decoded image.

FIG. 9 is a diagram for explaining an example of processing in a case where a luminance component of a reference frame is large.

FIG. 10 is a diagram for explaining an example of processing in a case where a luminance component of a reference frame is small.

FIG. 11 is a diagram illustrating an example of syntax extended so that a chroma format of a reference frame can be changed.

FIG. 12 is a diagram illustrating an example of sps_chroma_format_idc.

FIG. 13 is a block diagram illustrating a configuration example of an embodiment of an image processing system to which the present technology is applied.

FIG. 14 is a flowchart for explaining first image encoding processing.

FIG. 15 is a flowchart for explaining first image decoding processing.

FIG. 16 is a flowchart for explaining second image encoding processing.

FIG. 17 is a flowchart for explaining second image decoding processing.

FIG. 18 is a flowchart for explaining processing of reducing and enlarging a reference frame in second image decoding processing.

FIG. 19 is a block diagram illustrating a configuration example of an embodiment of a computer-based system to which the present technology is applied.

FIG. 20 is a block diagram illustrating a configuration example of an embodiment of an image encoding apparatus.

FIG. 21 is a flowchart for explaining encoding processing.

FIG. 22 is a block diagram illustrating a configuration example of an embodiment of an image decoding apparatus.

FIG. 23 is a flowchart for explaining decoding processing.

FIG. 24 is a block diagram illustrating a configuration example of an embodiment of a computer to which the present technology is applied.

### MODE FOR CARRYING OUT THE INVENTION

<Documents and the Like that Support Technical Contents and Technical Terms>

The scope disclosed herein is not limited to the contents of the examples, and the contents of the following reference documents REF1 to REF3 known at the time of filing are also incorporated herein by reference. That is, the contents described in the following reference documents REF1 to REF3 are also grounds for determining the support requirement.

For example, a quad-treeblock structure, a quad tree plus binary tree (QTBT) block structure, and a multi-type tree (MTT) block structure are within the scope of the present disclosure and satisfy the support requirements of the claims even in a case where they are not directly defined in the detailed description of the invention. Furthermore, for example, technical terms such as parsing, syntax, and semantics are similarly within the scope of the present disclosure and satisfy the support requirements of the claims even in a case where not directly defined in the detailed description of the invention.

REF1: Recommendation ITU-T H.264 (April 2017) “Advanced video coding for generic audiovisual services”, April 2017

REF2: Recommendation ITU-T H.265 (November 2019) “High efficiency video coding”, February 2018

REF3: Recommendation ITU-T H.266 (August 2020) “Versatile video coding”

### <Terms>

In the present application, the following terms are defined as follows.

### <Block>

“Block” (that is not a block indicating a processing unit) used for description as a partial region or a unit of processing of an image (a picture) indicates any partial region in the picture unless otherwise specified, and a size, a shape, characteristics, and the like are not limited. For example, “block” is to include any partial region (a unit of processing) such as a transform block (TB), a transform unit (TU), a prediction block (PB), a prediction unit (PU), a smallest coding unit (SCU), a coding unit (CU), a largest coding unit (LCU), a coding treeblock (CTB), a coding tree unit (CTU), a transform block, a sub-block, a macro block, a tile, or a slice.

### <Specification of Block Size>

Furthermore, in specifying a size of such a block, it is also possible to indirectly specify the block size in addition to directly specifying the block size. For example, the block size may be specified using identification information that identifies the size. Furthermore, for example, the block size may be specified by a ratio or difference with the size of the reference block (for example, LCU, SCU, or the like). For example, in a case of transmitting information for specifying the block size as a syntax element or the like, information for indirectly specifying the size as described above may be used as this information. By doing so, an information amount of the information can be reduced, and encoding efficiency may be improved in some cases. Furthermore, the specification of the block size also includes specification of a range of the block size (for example, specification of the range of an allowable block size and the like).

### <Unit of Information/Processing>

The data units in which the various types of information are set and the data units targeted by the various processes are arbitrary and are not limited to the above-described examples. For example, these pieces of information and processing may be individually set for each transform unit (TU), transform block (TB), prediction unit (PU), prediction block (PB), coding unit (CU), largest coding unit (LCU), sub-block, block, tile, slice, picture, sequence, or component, or may target data of those units of data. Of course, this data unit can be set for every pieces of information or process, and it is not necessary that the data units of all the pieces of information or processes are unified. Note that the storage location of these pieces of information is arbitrary, and may be stored in a header, parameter set, or the like of the above-described data units. Furthermore, it may be stored in a plurality of places.

### <Control Information>

Control information related to the present technology may be transmitted from an encoding side to a decoding side. For example, control information (for example, enabled_flag) that controls whether or not the application of the present technology described above is permitted (or prohibited) may be transmitted. Furthermore, for example, control information indicating a target to which the present technology described above is applied (or a target to which the present technology is not applied) may be transmitted. For example, control information specifying a block size (upper limit or lower limit, or both), a frame, a component, a layer, or the like to which the present technology is applied (or application is permitted or prohibited) may be transmitted.

### <Flag>

Note that, in the present specification, “flag” is information for identifying a plurality of states, and includes not only information to be used for identifying two states of true (1) or false (0), but also information that enables identification of three or more states. Hence, a value that may be taken by the “flag” may be, for example, a binary of 1/0 or a ternary or more. That is, the number of bits forming this “flag” is any number, and may be one bit or a plurality of bits. Furthermore, identification information (including the flag) is assumed to include not only identification information thereof in a bitstream but also difference information of the identification information with respect to certain reference information in the bitstream, and thus, in the present specification, the “flag” and “identification information” include not only the information thereof but also the difference information with respect to the reference information.

### <Associating Metadata>

Furthermore, various types of information (such as metadata) regarding coded data (bitstream) may be transmitted or recorded in any form as long as this is associated with the coded data. Herein, the term “associate” is intended to mean to make, when processing one data, the other data available (linkable), for example. That is, the data associated with each other may be collected as one data or may be made individual data. For example, information associated with the coded data (image) may be transmitted on a transmission path different from that of the coded data (image).

Furthermore, for example, the information associated with the coded data (image) may be recorded in a recording medium different from that of the coded data (image) (or another recording area of the same recording medium). Note that, this “association” may be of not entire data but a part of data. For example, an image and information corresponding to the image may be associated with each other in any unit such as a plurality of frames, one frame, or a part within a frame.

Note that, in the present specification, terms such as “combine”, “multiplex”, “add”, “merge”, “include”, “store”, “put in”, “introduce”, and “insert” mean, for example, to combine a plurality of objects into one, such as to combine coded data and metadata into one data, and mean one method of “associating” described above. Furthermore, in the present specification, encoding includes not only entire processing of transforming an image into a bitstream but also a part of the processing. For example, in addition to processing including prediction processing, orthogonal transform, quantization, arithmetic coding and the like, processing collectively including the quantization and arithmetic coding, processing including the prediction processing, quantization, and arithmetic coding and the like are also included. Similarly, decoding includes not only entire processing of transforming a bitstream into an image but also a part of the processing. For example, in addition to processing including inverse arithmetic decoding, inverse quantization, inverse orthogonal transform, prediction processing and the like, processing including the inverse arithmetic decoding and inverse quantization, processing including the inverse arithmetic decoding, inverse quantization, and prediction processing and the like are also included.

The prediction block means a block serving as a unit of processing when inter prediction is performed, and also includes a sub-block in the prediction block. Furthermore, in a case where the orthogonal transform block serving as a unit of processing when the orthogonal transform is performed or the encoding block serving as a unit of processing when the encoding processing is performed is the same as the unit of processing, the prediction block and the orthogonal transform block/encoding block mean the same block.

The inter prediction is a generic term for processing involving prediction between frames (prediction blocks), such as derivation of a motion vector by motion detection (motion prediction/motion estimation) and motion compensation using a motion vector, and includes some processing (for example, only motion compensation processing) or all processing (for example, motion detection processing+motion compensation processing) used for generating a predicted image. The inter prediction mode includes variables (parameters) referred to when deriving the inter prediction mode, such as a mode number, an index of the mode number, a block size of the prediction block, and a size of a sub-block serving as a unit of processing in the prediction block when the inter prediction is performed.

In the present disclosure, identification data for identifying a plurality of patterns can also be set as syntax of a bitstream. In this case, the decoder can perform processing more efficiently by parsing and referring to the identification data. The method (data) of identifying the block size includes not only a method (bitwise conversion) of quantifying the block size itself but also a method (data) of identifying a difference value with respect to the block size (maximum block size, minimum block size, or the like) serving as a reference.

Hereinafter, specific embodiments according to the present technology will be described in detail with reference to the drawings.

### <Concept of Image Processing>

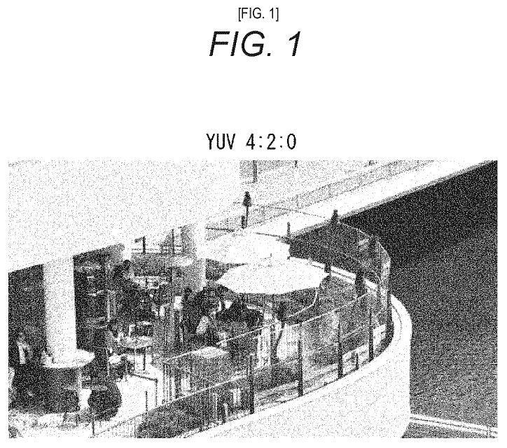

A concept of image processing to which the present technology is applied will be described with reference to FIGS. 1 to 12.

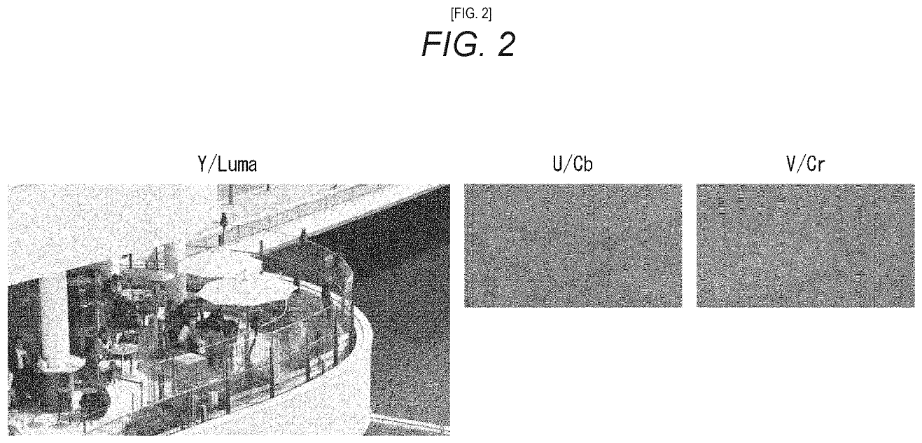

FIG. 1 illustrates an example of an image (YUV 4:2:0) used in the image processing described with reference to FIGS. 2 to 10.

When the image (YUV 4:2:0) as illustrated in FIG. 1 is divided into a luminance component (luma component) Y, a chrominance component (chroma component) U, and a chrominance component (chroma component) V and displayed, as illustrated in FIG. 2, the resolutions of the chrominance component U and the chrominance component V are half the resolution of the luminance component Y.

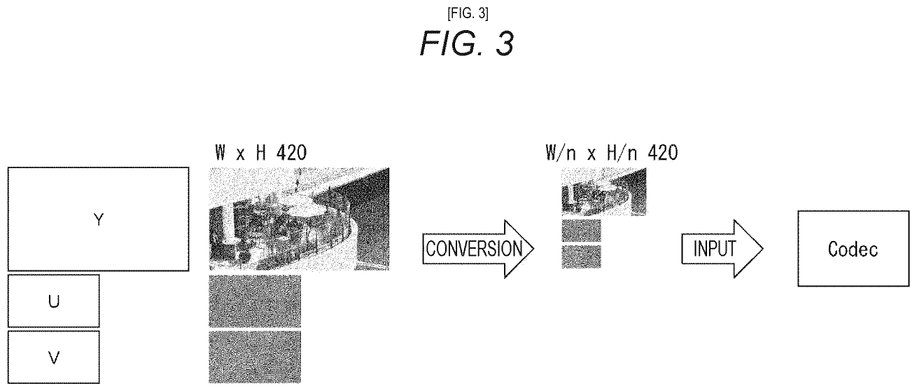

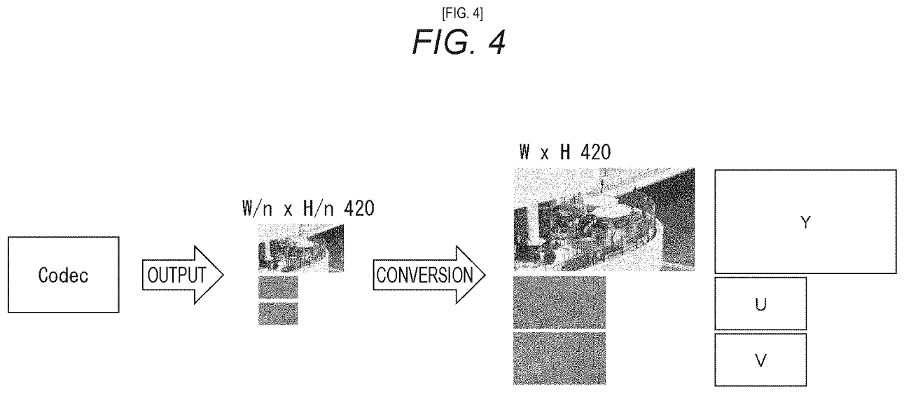

Then, on the encoding side, as illustrated in FIG. 3, after reduction processing of converting the resolution of the image (W×H, YUV 4:2:0) to 1/n times is performed, the image (W/n×H/n, YUV 4:2:0) is input to the encoder. On the decoding side, as illustrated in FIG. 4, by performing enlargement processing to convert the resolution of the image (W/n×H/n, YUV 4:2:0) output from the decoder into n times, it is possible to acquire the restored image (W×H, YUV 4:2:0).

In general, when an image is reduced, high frequency components are lost due to aliasing distortion removal. Therefore, the chrominance component U and the chrominance component V are reduced to be smaller, so that a high-frequency component is removed from the luminance component Y. Therefore, the image quality of the chrominance component U and the chrominance component V is degraded.

For example, in a case where an image having a high resolution (for example, 4K) is encoded at a low bit rate (for example, single-digit Mbps) with an increased compression rate, there is a situation where the subjective image quality becomes poor in a state where noise is conspicuous as the encoding distortion increases, and it becomes difficult to secure the image quality. In such a case, it is also assumed that the resolution is lowered (for example, HD) to encode the image in order to secure (or improve) the image quality. In the present embodiment, the main purpose is to protect the resolution of the chrominance component while maintaining a low bit rate, and to suppress deterioration in image quality of the chrominance component. Here, the low bit rate is a measure of a bit rate at which an effect is exhibited in such a main viewpoint, and is not limited to a specific numerical value as long as it is within a range in which an equivalent effect is exhibited. Typically, in a case where the image quality is stricter than the bit rate in a case where an image with high resolution is encoded, a case where an image with lower resolution is encoded at a similar bit rate is assumed.

Similarly, in the RPR which is one of the functions of the VVC, the image quality of the chrominance component U and the chrominance component V is degraded.

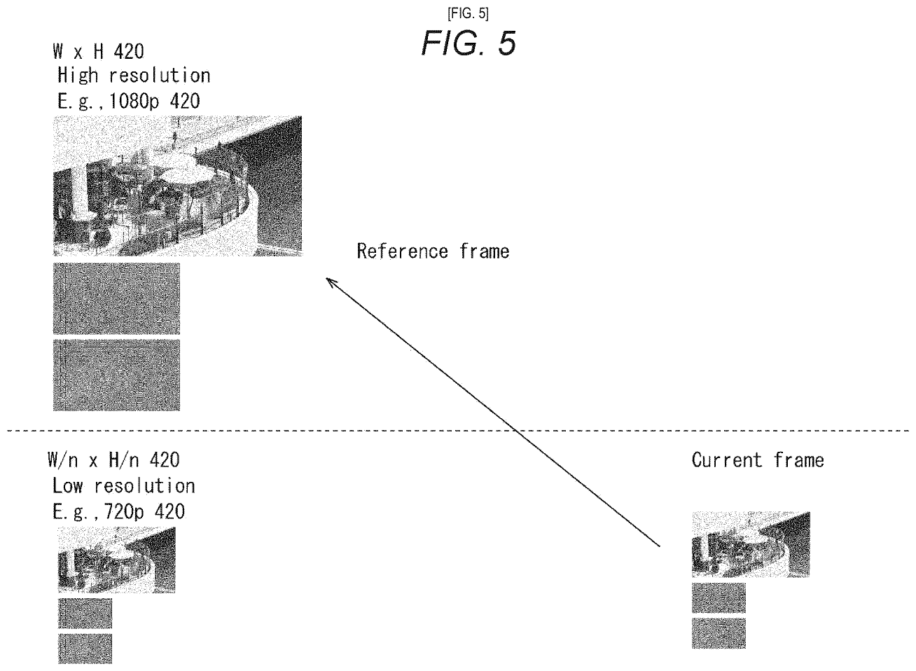

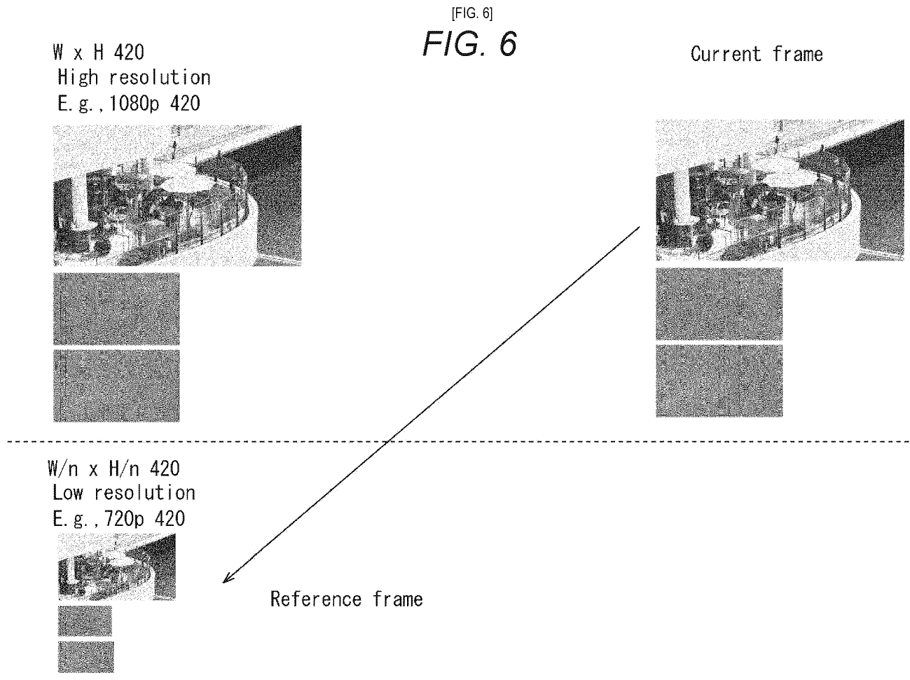

For example, in RPR, the reference frame and the current frame may have different resolutions. Therefore, as illustrated in FIG. 5, the resolution and the chroma format of the reference frame may be 1080p and YUV 4:2:0, and the resolution and the chroma format of the current frame may be 720p and YUV 4:2:0. Also, as illustrated in FIG. 6, the resolution and chroma format of the reference frame may be 720p and YUV 4:2:0, and the resolution and chroma format of the current frame may be 1080p and YUV 4:2:0.

As described above, in the RPR, when the resolution is changed, the resolution of the chrominance component U and the chrominance component V is further reduced as described above, so that the image quality of the chrominance component U and the chrominance component V is degraded.

Therefore, the present embodiment is based on the concept that the resolution of the input image is reduced only for the luminance component Y, and the chrominance component U and the chrominance component V are not reduced, or the chrominance component U and the chrominance component V are reduced to a smaller extent than the reduction of the luminance component Y. For example, in a case where the chroma format of the original input image is YUV 4:2:0 or YUV 4:2:2, when the resolution of only the luminance component Y is reduced and the resolutions of the chrominance component U and the chrominance component V are not converted, the chroma format of the image is converted into YUV 4:4:4. Then, by performing encoding in a state where the chroma format of the image is YUV 4:4:4, it is possible to suppress deterioration in image quality of the chrominance component U and the chrominance component V.

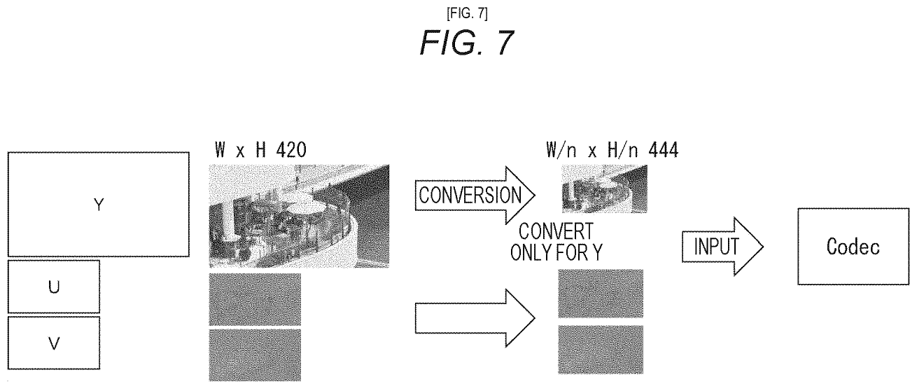

For example, on the encoding side, as illustrated in FIG. 7, an image (W/n×H/n, YUV 4:4:4) is generated by performing reduction processing of converting the resolution from the original image (W×H, YUV 4:2:0) to 1/n times only for the luminance component Y. This image (W/n×H/n, YUV 4:4:4) is input to an encoder to generate a bitstream.

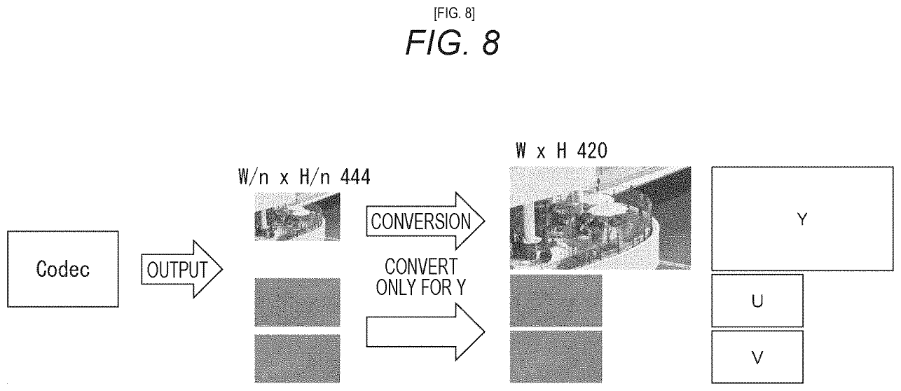

Then, on the decoding side, as illustrated in FIG. 8, an image (W/n×H/n, YUV 4:4:4) is output from the decoder by decoding the bitstream generated as described in FIG. 7. Then, the original image (W×H, YUV 4:2:0) can be acquired by performing enlargement processing of converting the resolution only for the luminance component Y to n times.

In addition, in the conventional RPR, the chroma format of the reference flate and the chroma format of the current frame are the same, but in the present technology, the chroma format of the reference flate and the chroma format of the current frame are extended so that different chroma formats can be used.

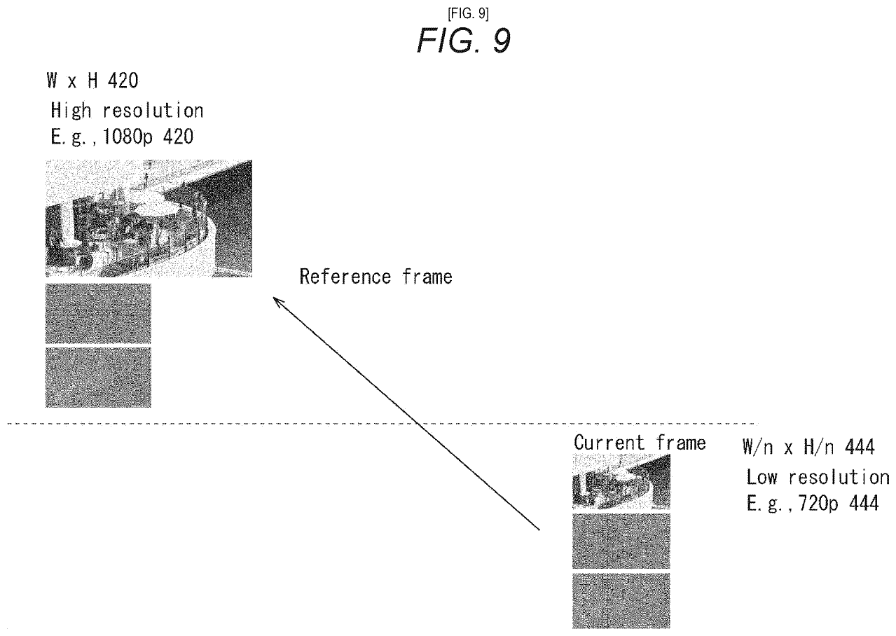

FIG. 9 illustrates an example in which the resolution and chroma format of the reference frame are 1080p and YUV 4:2:0, and the resolution and chroma format of the current frame are 720p and YUV 4:4:4. As illustrated, in a case where the resolution and the chroma format of the reference frame are 1080p and YUV 4:2:0, the resolution of the chrominance component U and the chrominance component V is half the resolution of the luminance component Y. Therefore, by setting the chroma format of the current frame to YUV 4:4:4, the reduction ratio of the chrominance component U and the chrominance component V can be suppressed to be low. As a result, deterioration of the chrominance component can be suppressed.

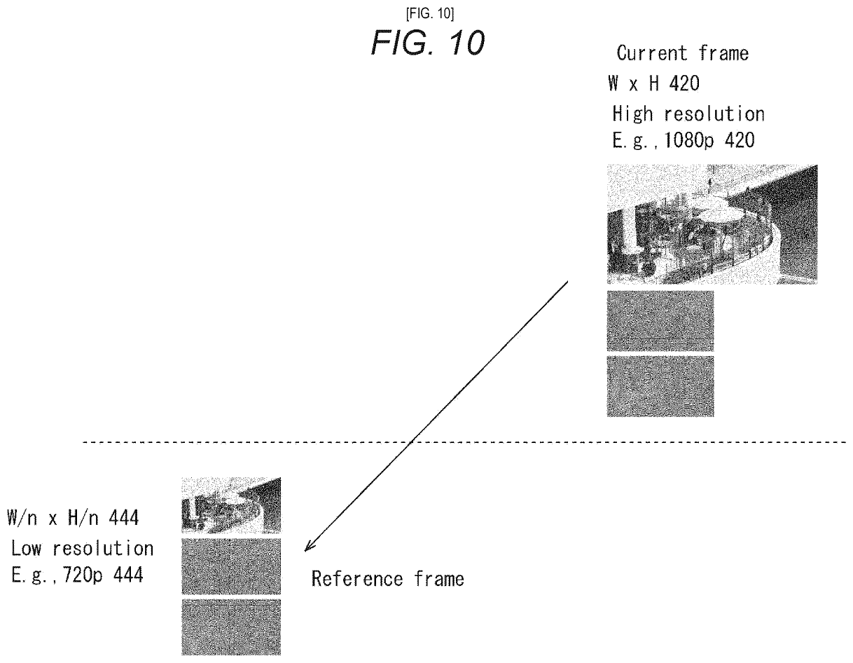

FIG. 10 illustrates an example in which the resolution and chroma format of the reference frame are 720p and YUV 4:4:4 and the resolution and chroma format of the current frame are 1080p and YUV 4:2:0. In this way, since the resolution and chroma format of the reference frame are 720p and YUV 4:4:4, the resolution and chroma format are different from those of the input. Therefore, by setting the chroma format of the current frame to 4:2:0, the original resolution and the chroma format can be restored.

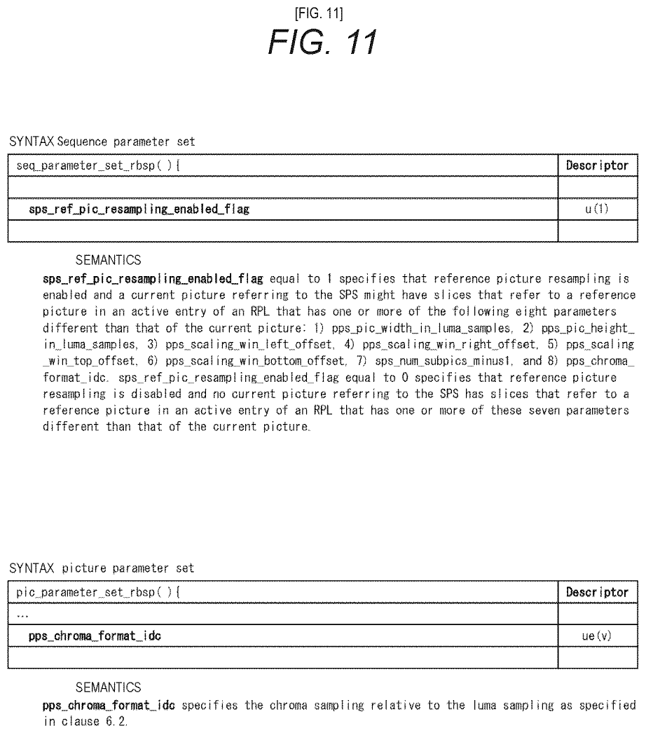

FIG. 11 illustrates an example of syntax of a sequence parameter set and a picture parameter set extended so that the chroma format of the reference frame can be changed.

For example, in a case where sps_ref_pic_resampling_enabled_flag of the sequence parameter set is set to 1, it is specified that resampling of a reference picture is enabled, and a current picture that refers to the sequence parameter set may include a slice that refers to a reference picture in an active entry of a reference picture set (RPS) with one or a plurality of the following eight parameters different from those of the current picture.
1) pps_pic_width_in_luma_samples
2) pps_pic_height_in_luma_samples
3) pps_scaling_win_left_offset
4) pps_scaling_win_right_offset
5) pps_scaling_win_top_offset
6) pps_scaling_win_bottom_offset
7) sps_num_subpics_minus1
8) pps_chroma_format_idc

On the other hand, in a case where sps_ref_pic_resampling_enabled_flag is set to 0, it is specified that the resampling of the reference picture is disabled, and the current picture that refers to the sequence parameter set does not have the slice that refers to the reference picture in the active entry of the reference picture set having one or more of eight parameters different from those of the current picture.

pps_chroma_format_idc of the picture parameter set is a parameter that specifies the sampling of the chrominance component U and the chrominance component V related to the sampling of the luminance component Y.

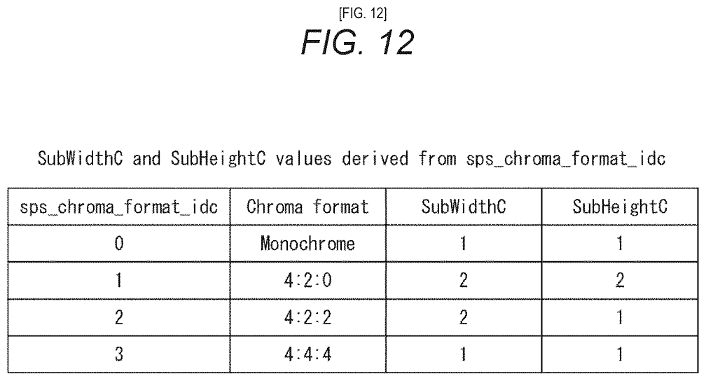

FIG. 12 is a diagram for explaining an example of sps_chroma_format_idc which is a parameter for specifying a chroma format for each picture.

As illustrated in FIG. 12, in a case where sps_chroma_format_idc is 0, the chroma format is specified as monochrome, SubWidthC is specified as 1, and SubHeightC is specified as 1. In a case where sps_chroma_format_idc is 1, the chroma format is specified as YUV 4:2:0, SubWidthC is specified as 2, and SubHeightC is specified as 2. In a case where sps_chroma_format_idc is 2, the chroma format is specified as YUV 4:2:2, SubWidthC is specified as 2, and SubHeightC is specified as 1. In a case where sps_chroma_format_idc is 3, the chroma format is specified as YUV 4:4:4, SubWidthC is specified as 1, and SubHeightC is specified as 1.

### Configuration Example of Image Processing System

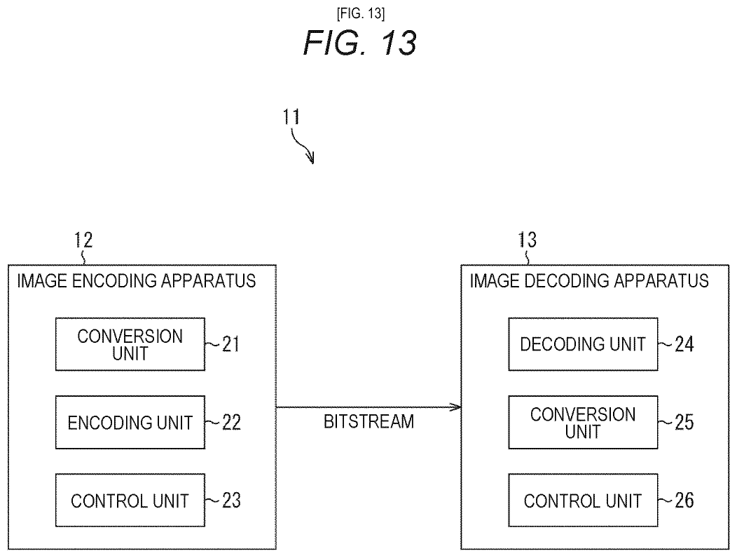

FIG. 13 is a block diagram illustrating a configuration example of an embodiment of an image processing system to which the present technology is applied.

As illustrated in FIG. 13, an image processing system 11 includes an image encoding apparatus 12 and an image decoding apparatus 13. For example, in the image processing system 11, a moving image input to the image encoding apparatus 12 is encoded, a bitstream obtained by the encoding is transmitted to the image decoding apparatus 13, and a moving image decoded from the bitstream in the image decoding apparatus 13 is output.

The image encoding apparatus 12 includes a conversion unit 21, an encoding unit 22, and a control unit 23.

The conversion unit 21 performs reduction processing of reducing the resolution only for the luminance component Y of the moving image including the luminance component Y, the chrominance component U, and the chrominance component V, converts the chroma format of the moving image from YUV 4:2:0 or YUV 4:2:2 to YUV 4:4:4, and supplies the converted chroma format to the encoding unit 22. Note that the conversion unit 21 may not reduce the chrominance component U and the chrominance component V, or may reduce the chrominance component U and the chrominance component V at a reduction ratio equal to or lower than the reduction ratio of the luminance component Y (that is, the luminance component Y is reduced to a smaller extent than the luminance component Y).

The encoding unit 22 encodes the moving image in which the resolution of the luminance component Y is reduced by the conversion unit 21, that is, the moving image in which the chroma format is converted into YUV 4:4:4 at a low bit rate to generate a bitstream. Then, the bitstream generated by the encoding unit 22 is transmitted from the image encoding apparatus 12 to the image decoding apparatus 13.

The control unit 23 controls a set of sps_ref_pic_resampling_enabled_flag which is a flag indicating whether or not it is valid to convert the chroma format of the moving image in the middle of the bitstream. Furthermore, in a case where sps_ref_pic_resampling_enabled_flag is set to 1, that is, in a case where it is effective to convert the chroma format of the moving image in the middle of the bitstream, the control unit 23 controls sps_chroma_format_idc, which is a parameter that specifies the chroma format for each picture of the moving image.

The image decoding apparatus 13 includes a decoding unit 24, a conversion unit 25, and a control unit 26.

The decoding unit 24 decodes the bitstream transmitted from the image encoding apparatus 12, generates a moving image including the luminance component Y, the chrominance component U, and the chrominance component V, and supplies the moving image to the conversion unit 25.

For example, in a case where the chroma format of the moving image supplied from the decoding unit 24 is YUV 4:4:4, the conversion unit 25 performs enlargement processing of enlarging the resolution only for the luminance component Y of the moving image, converts the chroma format of the moving image, and acquires a moving image of YUV 4:2:0 or YUV 4:2:2. Note that, in a case where the conversion unit 21 of the image encoding apparatus 12 reduces the chrominance component U and the chrominance component V, the conversion unit 25 also enlarges the chrominance component U and the chrominance component V according to the reduction ratio. Then, the moving image acquired by the conversion unit 25 is supplied to a display apparatus (not illustrated) and used for display.

In a case where it is effective to convert the chroma format of the moving image in the middle of the bitstream according to sps_ref_pic_resampling_enabled_flag, the control unit 26 controls the conversion of the chroma format of the moving image by the conversion unit 25 on the basis of sps_chroma_format_idc.

The image processing system 11 is configured as described above, and it is possible to reduce the degradation of the chrominance component U and the chrominance component V in the resolution reduction by reducing the resolution only for the luminance component Y or suppressing the reduction ratio of the chrominance component U and the chrominance component V to be low. In addition, by using sps_ref_pic_resampling_enabled_flag, in a case where the degree of congestion on the Internet line increases, the image processing system 11 can adaptively cope with the fluctuation in the band of the Internet line by converting the chroma format of the moving image in the middle of the bitstream and transmitting the bitstream of the low bit rate.

### <First Image Encoding Processing and First Image Decoding Processing>

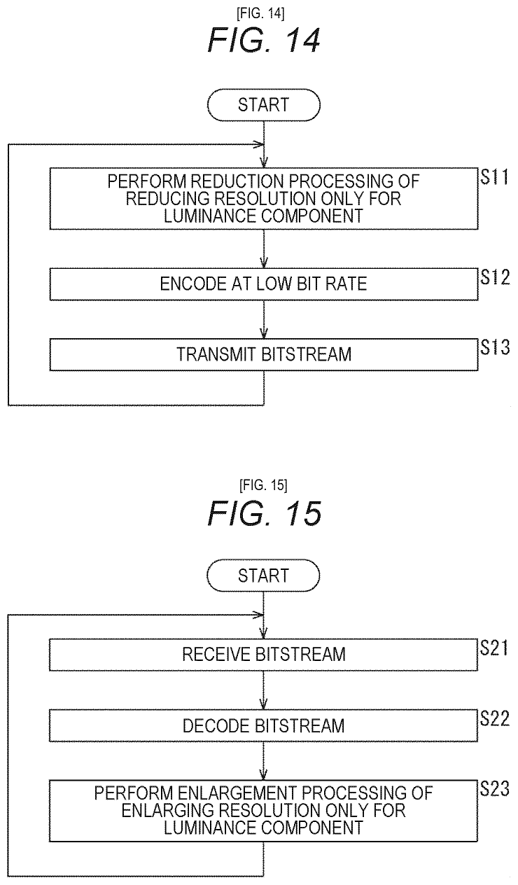

The first image encoding processing and the first image decoding processing performed in the image processing system 11 will be described with reference to FIGS. 14 and 15. For example, in a use case where the image processing system 11 transmits a moving image to an Internet line having a small band, and it is necessary to realize a very low bit rate, the first image encoding processing and the first image decoding processing are used.

FIG. 14 is a flowchart for explaining first image encoding processing performed by the image encoding apparatus 12.

In step S11, for example, when a moving image (1920×1080, YUV 4:2:0) with HD resolution is input to the image encoding apparatus 12, the conversion unit 21 performs reduction processing of reducing the resolution only for the luminance component Y of the moving image in order to perform encoding at a low bit rate. As a result, the conversion unit 21 acquires the moving image (960×540, YUV 4:4:4) and supplies the moving image to the encoding unit 22.

In step S12, the encoding unit 22 performs encoding processing of encoding the moving image (960×540, YUV 4:4:4) supplied from the conversion unit 21 in step S11 at a low bit rate, thereby generating a bitstream of a low bit rate.

In step S13, the image encoding apparatus 12 transmits the bitstream of the low bit rate generated in step S12 to the image decoding apparatus 13 via the Internet line. Thereafter, the processing returns to step S11, and similar processing is repeatedly performed until the transmission of the moving image is completed.

FIG. 15 is a flowchart for explaining first image decoding processing performed by the image decoding apparatus 13.

In step S21, the image decoding apparatus 13 receives the bitstream transmitted from the image encoding apparatus 12 via the Internet line, and inputs the bitstream to the decoding unit 24.

In step S22, the decoding unit 24 performs decoding processing on the bitstream input in step S21 to decode the bitstream into a moving image (960×540, YUV 4:4:4), and supplies the moving image to the conversion unit 25.

In step S23, the conversion unit 25 performs enlargement processing of enlarging the resolution only for the luminance component of the moving image decoded in step S22, thereby acquiring and outputting a moving image (1920×1080, YUV 4:2:0) having the same HD resolution as the original moving image input to the image encoding apparatus 12. Thereafter, the processing returns to step S21, and similar processing is repeatedly performed until the transmission of the moving image is completed.

As described above, in the first image encoding processing and the first image decoding processing, the resolution is reduced only for the luminance component Y, and the resolutions of the chrominance component U and the chrominance component V are not reduced. Therefore, it is possible to reduce the degradation of the chrominance component U and the chrominance component V in the resolution reduction. At this time, as the resolution of the luminance component Y decreases, improvement in encoding efficiency can be expected.

In addition, the first image encoding processing and the first image decoding processing can be performed without changing a conventional standard (RPR specification of VVC).

<Second Image Encoding Processing and Second Image Decoding Processing>

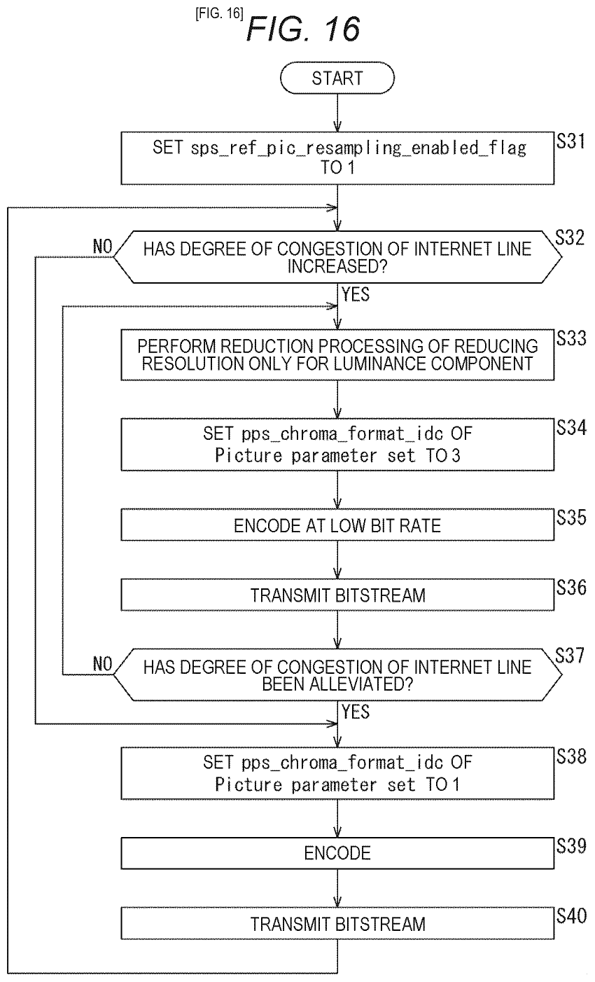

The second image encoding processing and the second image decoding processing performed in the image processing system 11 will be described with reference to FIGS. 16 to 18. For example, the second image encoding processing and the second image decoding processing are used in a use case where the image processing system 11 transmits a moving image to an Internet line whose band is likely to fluctuate and it is necessary to realize a very low bit rate.

FIG. 16 is a flowchart for explaining second image decoding processing performed by the image encoding apparatus 12.

In step S31, the control unit 23 sets sps_ref_pic_resampling_enabled_flag to 1 so that the bit rate can be dynamically lowered in the middle of streaming, that is, the resolution of the luminance component Y can be changed in the middle. As a result, the resolution and the chroma format of the reference frame can be changed so as to be different from the resolution and the chroma format of the current frame. In step S32, the control unit 23 determines whether or not the degree of congestion of the Internet line has increased.

For example, in a case where it is detected that the bandwidth of the Internet line has decreased until a certain level of communication speed cannot be secured, in step S32, the control unit 23 determines that the congestion degree of the Internet line has increased, and the processing proceeds to step S33.

In step S33, in order to further perform encoding at a low bit rate, the conversion unit 21 performs reduction processing of reducing the resolution only for the luminance component Y of the moving image (1920×1080, YUV 4:2:0) with the HD resolution, acquires the moving image (960×540, YUV 4:4:4), and supplies the moving image to the encoding unit 22. At this time, since the chrominance component U and the chrominance component V are not reduced, deterioration can be avoided.

In step S34, the control unit 23 sets pps_chroma_format_idc of the Picture parameter set to 3 in order to set the chroma format of the current frame to YUV 4:4:4. At this time, even if the resolution and the chroma format of the reference frame are 1920×1080 and YUV 4:2:0, the reference frame can be used for the reference frame of the inter prediction, so that improvement of the encoding efficiency can be expected.

In step S35, the encoding unit 22 performs encoding processing of encoding the moving image (960×540, YUV 4:4:4) supplied from the conversion unit 21 in step S33 at a low bit rate, thereby generating a bitstream of a low bit rate. At this time, the encoding efficiency can be improved by the reduction in the resolution of the luminance component Y.

In step S36, the image encoding apparatus 12 transmits the bitstream of the low bit rate generated in step S35 to the image decoding apparatus 13 via the Internet line.

In step S37, the control unit 23 determines whether or not the degree of congestion of the Internet line has been alleviated.

For example, in a case where it is detected that the bandwidth of the Internet line has increased to a level at which the communication speed or higher can be secured, in step S37, the control unit 23 determines that the congestion degree of the Internet line has been alleviated, and the processing proceeds to step S38. That is, in this case, the original bit rate is increased. On the other hand, in step S37, in a case where the control unit 23 determines that the congestion degree of the Internet line is not alleviated, the processing returns to step S33, and similar processing is repeatedly performed. Note that, also in a case where the control unit 23 determines in step S32 that the degree of congestion of the Internet line has not increased, the processing proceeds to step S38.

In step S38, the control unit 23 sets pps_chroma_format_idc of the Picture parameter set to 1 in order to return the chroma format of the current frame to YUV 4:2:0. At this time, even if the resolution and the chroma format of the reference frame are 960×540 and YUV 4:4:4, the reference frame can be used for the reference frame of the inter prediction, so that improvement of the encoding efficiency can be expected.

In step S39, the encoding unit 22 generates a bitstream by performing encoding processing of encoding a moving image (1920×1080, YUV 4:2:0) with HD resolution as an input. That is, the reduction processing of the luminance component Y by the conversion unit 21 is stopped.

In step S40, the image encoding apparatus 12 transmits the bitstream generated in step S39 to the image decoding apparatus 13 via the Internet line. Thereafter, the processing returns to step S31, and similar processing is repeatedly performed until the transmission of the moving image is completed.

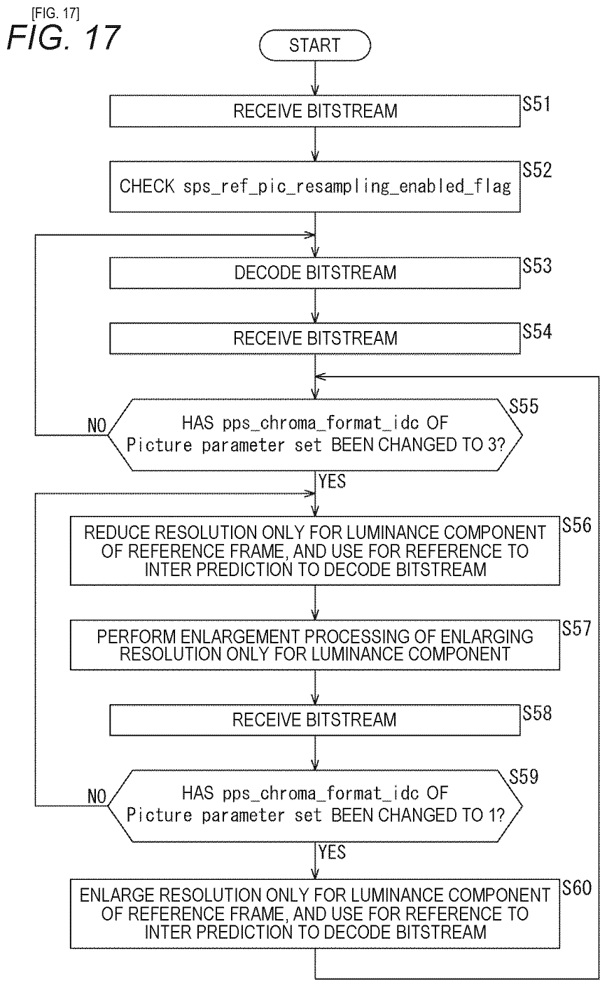

FIG. 17 is a flowchart for explaining second image decoding processing performed by the image decoding apparatus 13.

In step S51, the image decoding apparatus 13 receives the bitstream transmitted from the image encoding apparatus 12 via the Internet line, and inputs the bitstream to the decoding unit 24 and the control unit 26.

In step S52, the control unit 26 reads and checks sps_ref_pic_resampling_enabled_flag from the bitstream input in step S51. As described above, in step S31 of FIG. 16, sps_ref_pic_resampling_enabled_flag is set to 1, and the control unit 26 confirms that sps_ref_pic_resampling_enabled_flag is 1, that is, the resolution and chroma format of the reference frame can be changed to be different from the resolution and chroma format of the current frame.

In step S53, the decoding unit 24 performs decoding processing on the bitstream input in step S51. Here, in a stage where the decoding processing is started in the image decoding apparatus 13, the resolution and the chroma format of the image are 1920×1080 and YUV 4:2:0, and the decoding unit 24 decodes the bitstream into a moving image (1920×1080, YUV 4:2:0) and outputs the moving image.

In step S54, the image decoding apparatus 13 receives the bitstream transmitted from the image encoding apparatus 12 via the Internet line, and inputs the bitstream to the decoding unit 24 and the control unit 26.

In step S55, the control unit 26 reads pps_chroma_format_idc of the Picture parameter set from the bitstream input in step S51, and determines whether or not pps_chroma_format_idc of the Picture parameter set has been changed to 3.

In step S55, in a case where the control unit 26 determines that pps_chroma_format_idc of the Picture parameter set has not been changed to 3, the processing returns to step S53, and similar processing is repeatedly performed thereafter.

On the other hand, in step S55, in a case where the control unit 26 determines that pps_chroma_format_idc of the Picture parameter set has been changed to 3, the processing proceeds to step S56. That is, in this case, it is specified that the resolution and the chroma format of the current frame are changed to 960×540 and YUV 4:4:4.

In step S56, the decoding unit 24 acquires a moving image (960×540, YUV 4:4:4) by reducing the resolution only for the luminance component Y of the reference frame, and uses the moving image for reference to inter prediction to perform decoding processing on the bitstream input in step S54. As a result, the decoding unit 24 decodes the bitstream into a moving image (960×540, YUV 4:4:4) and supplies the moving image to the conversion unit 25.

In step S57, the conversion unit 25 performs enlargement processing of enlarging the resolution only for the luminance component Y of the moving image decoded in step S56, thereby acquiring and outputting a moving image (1920×1080, YUV 4:2:0) having the same HD resolution as the original moving image input to the image encoding apparatus 12.

In step S58, the image decoding apparatus 13 receives the bitstream transmitted from the image encoding apparatus 12 via the Internet line, and inputs the bitstream to the decoding unit 24 and the control unit 26.

In step S59, the control unit 26 reads pps_chroma_format_idc of the Picture parameter set from the bitstream input in step S58, and determines whether or not pps_chroma_format_idc of the Picture parameter set has been changed to 1.

In step S59, in a case where the control unit 26 determines that pps_chroma_format_idc of the Picture parameter set has not been changed to 1, the processing returns to step S56, and similar processing is repeatedly performed thereafter.

On the other hand, in step S59, in a case where the control unit 26 determines that pps_chroma_format_idc of the Picture parameter set has been changed to 1, the processing proceeds to step S60. That is, in this case, it is specified that the resolution and the chroma format of the current frame are changed to 1920×1080 and YUV 4:2:0.

In step S60, the decoding unit 24 acquires a moving image (1920×1080, YUV 4:2:0) by enlarging the resolution only for the luminance component Y of the reference frame, and uses the moving image for reference to inter prediction to perform decoding processing on the bitstream input in step S58. As a result, the decoding unit 24 decodes the bitstream into a moving image (1920×1080, YUV 4:2:0) and outputs the moving image.

Thereafter, the processing returns to step S55, and similar processing is repeatedly performed until the transmission of the moving image is completed.

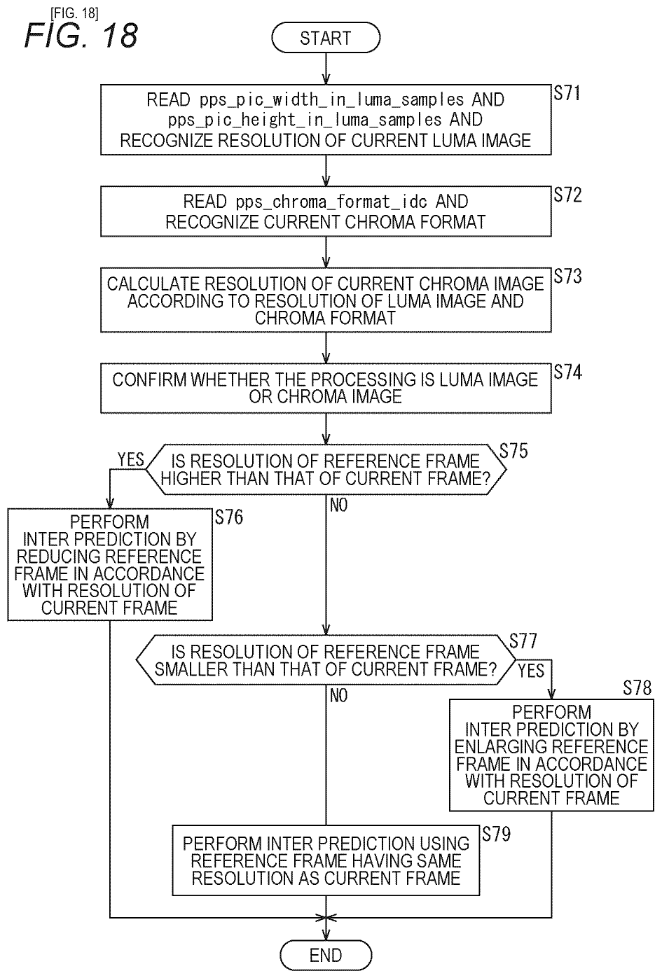

Processing of reducing and enlarging the reference frame in the second image decoding processing will be described with reference to the flowchart illustrated in FIG. 18.

In step S71, the control unit 26 reads pps_pic_width_in_luma_samples and pps_pic_height_in_luma_samples from the bitstream, and recognizes the resolution of the luma image (image of the luminance component Y) in the current frame.

In step S72, the control unit 26 reads pps_chroma_format_idc from the bitstream and recognizes the chroma format in the current frame.

In step S73, the control unit 26 derives (calculates) the resolution of the chroma image (the images of the chrominance component U and the chrominance component V) in the current frame according to the resolution of the luma image in the current frame and the chroma format in the current frame.

In step S74, the control unit 26 confirms whether the processing is the luma image or the chroma image. Here, when the processing is confirmed to be the luma image, the processing on the luma image is performed in the following, and when the processing is confirmed to be the chroma image, the processing on the chroma image is performed in the following.

In step S75, the control unit 26 determines whether or not the resolution of the reference frame is higher than that of the current frame.

In a case where it is determined in step S75 that the resolution of the reference frame is larger than that of the current frame, the processing proceeds to step S76. In step S76, the decoding unit 24 performs inter prediction by reducing the reference frame in accordance with the resolution of the current frame, and performs decoding processing on the bitstream.

On the other hand, in a case where it is determined in step S75 that the resolution of the reference frame is not higher than that of the current frame, the processing proceeds to step S77, and the control unit 26 determines whether or not the resolution of the reference frame is lower than that of the current frame.

In a case where it is determined in step S77 that the resolution of the reference frame is smaller than that of the current frame, the processing proceeds to step S78. In step S78, the decoding unit 24 performs inter prediction by enlarging the reference frame in accordance with the resolution of the current frame, and performs decoding processing on the bitstream.

On the other hand, in a case where it is determined in step S77 that the resolution of the reference frame is not smaller than that of the current frame, the processing proceeds to step S79. That is, in this case, the current frame and the reference frame have the same resolution. Therefore, in step S79, the decoding unit 24 performs inter prediction using a reference frame having the same resolution as the current frame and performs decoding processing on the bitstream.

After the processing of step S76, step S78, or step S79, the processing ends.

As described above, in the second image encoding processing and the second image decoding processing, by using sps_ref_pic_resampling_enabled_flag, it is possible to adaptively cope with transmission of a moving image via an Internet line whose band is likely to fluctuate. Furthermore, even if the resolution of the current frame is different from the resolution of the reference frame, the inter prediction can be performed by reducing or enlarging the reference frame.

### Configuration Example of Computer-Based System

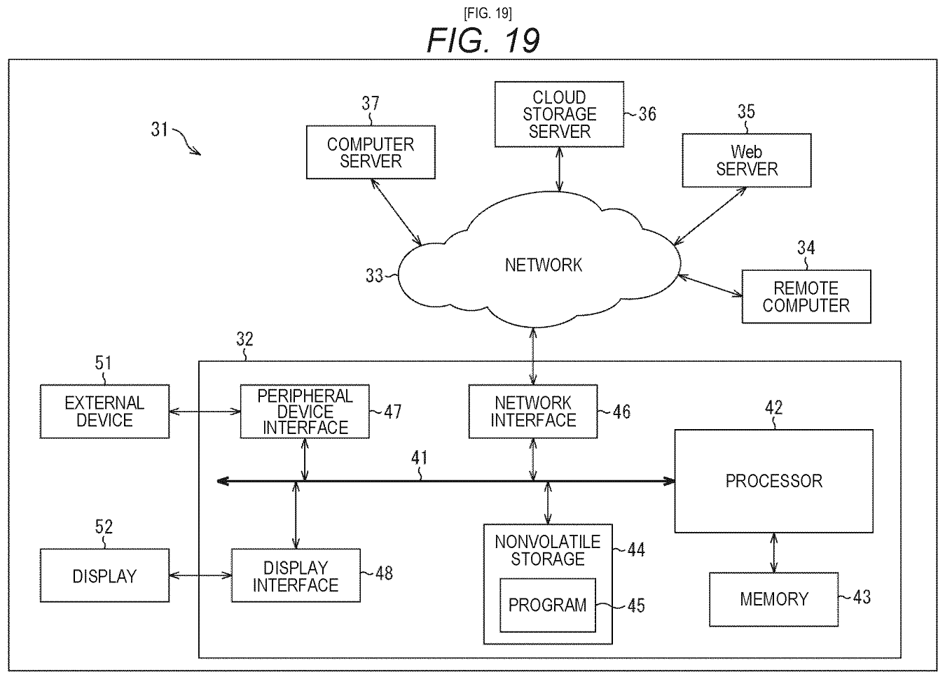

FIG. 19 is a block diagram illustrating a configuration example of a network system in which one or a plurality of computers, servers, and the like are connected via a network. It should be noted that the hardware and software environment illustrated in the embodiment of FIG. 19 is illustrated as an example where a platform may be provided for implementing software and/or methods according to the present disclosure.

As illustrated in FIG. 19, the network system 31 includes a computer 32, a network 33, a remote computer 34, a web server 35, a cloud storage server 36, and a computer server 37. Here, in the present embodiment, a plurality of instances is executed by one or a plurality of the functional blocks illustrated in FIG. 19.

Furthermore, FIG. 19 illustrates a detailed configuration of the computer 32. It should be noted that the functional blocks illustrated in the computer 32 are illustrated to establish exemplary functions and are not limited to such configurations. Furthermore, although detailed configurations of the remote computer 34, the web server 35, the cloud storage server 36, and the computer server 37 are not illustrated, these include configurations similar to the functional blocks illustrated in the computer 32.

Computer 32 may be a personal computer, a desktop computer, a laptop computer, a tablet computer, a netbook computer, a personal digital assistant, a smartphone, or other programmable electronic device capable of communicating with other devices on a network.

Then, the computer 32 includes a bus 41, a processor 42, a memory 43, a nonvolatile storage 44, a network interface 46, a peripheral device interface 47, and a display interface 48. Each of these functions may be implemented in an individual electronic subsystem (an integrated circuit chip or a combination of a chip and associated devices) in certain embodiments, or some of the functions may be combined and implemented in a single chip (system on chip or SoC) in other embodiments.

The bus 41 may employ various proprietary or industry standard high speed parallel or serial peripheral interconnect buses.

The processor 42 may employ those designed and/or manufactured as one or a plurality of single or multi-chip microprocessors.

The memory 43 and the nonvolatile storage 44 are storage media that can be read by the computer 32. For example, the memory 43 may employ any suitable volatile storage device, such as a dynamic random access memory (DRAM), a static RAM (SRAM), or the like. The nonvolatile storage 44 may employ at least one or more of a flexible disk, a hard disk, a solid state drive (SSD), a read only memory (ROM), an erasable and programmable read only memory (EPROM), a flash memory, a compact disk (CD or CD-ROM), a digital versatile disc (DVD), a card-type memory, or a stick-type memory.

In addition, a program 45 is stored in the nonvolatile storage 44. The program 45 is, for example, a collection of machine-readable instructions and/or data used to create, manage, and control certain software functions. Note that, in a configuration in which the memory 43 is much faster than the nonvolatile storage 44, the program 45 can be transferred from the nonvolatile storage 44 to the memory 43 before being executed by the processor 42.

The computer 32 can communicate with and interact with other computers via the network 33 via the network interface 46. The network 33 may employ a configuration including wired, wireless, or optical fiber connection by, for example, a local area network (LAN), a wide area network (WAN) such as the Internet, or a combination of LAN and WAN. In general, the network 33 is constituted by any combination of connections and protocols that support communication between two or more computers and associated devices.

The peripheral device interface 47 can input and output data to and from other devices that can be locally connected to the computer 32. For example, the peripheral device interface 47 provides a connection to an external device 51. As the external device 51, a keyboard, a mouse, a keypad, a touch screen, and/or other suitable input devices are used. The external device 51 may also include portable computer-readable storage media, such as, for example, thumb drives, portable optical or magnetic disks, and memory cards.

In embodiments of the present disclosure, for example, software and data used to implement the program 45 may be stored in such a portable computer readable storage medium. In such embodiments, software may be loaded into the nonvolatile storage 44 or directly into the memory 43 via the peripheral device interface 47. The peripheral device interface 47 may use an industry standard, such as RS-232 or universal serial bus (USB), for example, for connection with the external device 51.

The display interface 48 may connect the computer 32 to the display 52, and the display 52 may be used to present a command line or graphical user interface to a user of the computer 32. For example, as the display interface 48, an industry standard such as video graphics array (VGA), digital visual interface (DVI), display port, or high-definition multimedia interface (HDMI) (registered trademark) can be adopted.

### Configuration Example of Image Encoding Apparatus

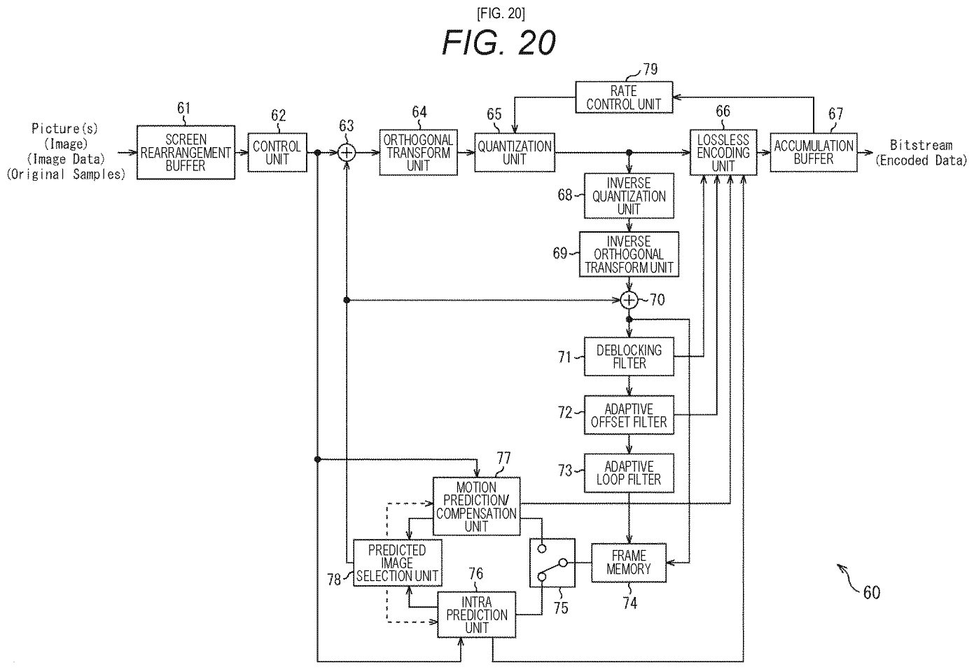

FIG. 20 illustrates a configuration of an embodiment of an image encoding apparatus as an image processing apparatus to which the present disclosure is applied.

An image encoding apparatus 60 illustrated in FIG. 20 encodes image data using prediction processing. Here, as the encoding scheme, for example, a high efficiency video coding (HEVC) scheme or the like is used.

The image encoding apparatus 60 in FIG. 20 includes a screen rearrangement buffer 61, a control unit 62, a calculation unit 63, an orthogonal transform unit 64, a quantization unit 65, a lossless encoding unit 66, and an accumulation buffer 67. Furthermore, the image encoding apparatus 60 includes an inverse quantization unit 68, an inverse orthogonal transform unit 69, a calculation unit 70, a deblocking filter 71, an adaptive offset filter 72, an adaptive loop filter 73, a frame memory 74, a selection unit 75, an intra prediction unit 76, a motion prediction/compensation unit 77, a predicted image selection unit 78, and a rate control unit 79.

The screen rearrangement buffer 61 stores the input image data (picture(s)), and rearranges the images of the frames in the stored display order in the order of frames for encoding according to a group of picture (GOP) structure. The screen rearrangement buffer 61 outputs the image in which the order of the frames has been rearranged to the calculation unit 63, the intra prediction unit 76, and the motion prediction/compensation unit 77 via the control unit 62. Here, the chroma format of the image data input to the screen rearrangement buffer 61 has been converted into YUV 4:4:4 by the conversion unit 21 in FIG. 13.

The control unit 62 controls reading of an image from the screen rearrangement buffer 61.

The calculation unit 63 subtracts the predicted image supplied from the intra prediction unit 76 or the motion prediction/compensation unit 77 via the predicted image selection unit 78 from the image output from the control unit 62, and outputs the difference information to the orthogonal transform unit 64.

For example, in the case of an image to which intra encoding is performed, the calculation unit 63 subtracts the predicted image supplied from the intra prediction unit 76 from the image output from the control unit 62. Furthermore, for example, in the case of an image to which inter encoding is performed, the calculation unit 63 subtracts the predicted image supplied from the motion prediction/compensation unit 77 from the image output from the control unit 62.

The orthogonal transform unit 64 performs orthogonal transform such as discrete cosine transform or Karhunen-Loeve transform on the difference information supplied from the calculation unit 63, and supplies a transform coefficient thereof to the quantization unit 65.

The quantization unit 65 quantizes the transform coefficient output from the orthogonal transform unit 64. The quantization unit 65 supplies the quantized transform coefficient to the lossless encoding unit 66.

The lossless encoding unit 66 performs lossless encoding such as variable-length coding and arithmetic coding on the quantized transform coefficient.

The lossless encoding unit 66 acquires parameters such as information indicating the intra prediction mode from the intra prediction unit 76, and acquires parameters such as information indicating the inter prediction mode and motion vector information from the motion prediction/compensation unit 77.

The lossless encoding unit 66 encodes the quantized transform coefficient and encodes each acquired parameter (syntax element) to be a part of (multiplexes) header information of coded data. The lossless encoding unit 66 supplies the coded data obtained by encoding to the accumulation buffer 67 for accumulation.

For example, the lossless encoding unit 66 performs lossless encoding processing such as variable-length coding or arithmetic coding. Examples of the variable-length coding include context-adaptive variable length coding (CAVLC). The arithmetic coding includes context-adaptive binary arithmetic coding (CABAC) and the like.

The accumulation buffer 67 temporarily holds the encoded stream (encoded data) supplied from the lossless encoding unit 66, and outputs the encoded stream as an encoded image encoded to, for example, a recording apparatus, a transmission path, or the like (not illustrated) in a subsequent stage at a predetermined timing. That is, the accumulation buffer 67 is also a transmission unit that transmits an encoded stream.

Furthermore, the transform coefficient quantized by the quantization unit 65 is also supplied to the inverse quantization unit 68. The inverse quantization unit 68 inversely quantizes the quantized transform coefficient by a method corresponding to the quantization by the quantization unit 65. The inverse quantization unit 68 supplies the obtained transform coefficient to the inverse orthogonal transform unit 69.

The inverse orthogonal transform unit 69 inversely orthogonally transforms the supplied transform coefficient by a method corresponding to the orthogonal transform process by the orthogonal transform unit 64. The output subjected to the inverse orthogonal transform (restored difference information) is supplied to the calculation unit 70.

The calculation unit 70 adds the predicted image supplied from the intra prediction unit 76 or the motion prediction/compensation unit 77 via the predicted image selection unit 78 to the inverse orthogonal transform result supplied from the inverse orthogonal transform unit 69, that is, the restored difference information, to obtain a locally decoded image (decoded image).

For example, in a case where the difference information corresponds to an image to which intra encoding is performed, the calculation unit 70 adds the predicted image supplied from the intra prediction unit 76 to the difference information. Furthermore, for example, in a case where the difference information corresponds to an image to which inter encoding is performed, the calculation unit 70 adds the predicted image supplied from the motion prediction/compensation unit 77 to the difference information.

The decoded image that is the addition result is supplied to the deblocking filter 71 and the frame memory 74.

The deblocking filter 71 appropriately performs deblocking filter processing on the image from the calculation unit 70 to suppress block distortion of the decoded image, and supplies the filter processing result to the adaptive offset filter 72. The deblocking filter 71 has parameters β and Tc obtained based on the quantization parameter OP. The parameters β and Tc are threshold values (parameters) used for the determination related to the deblocking filter.

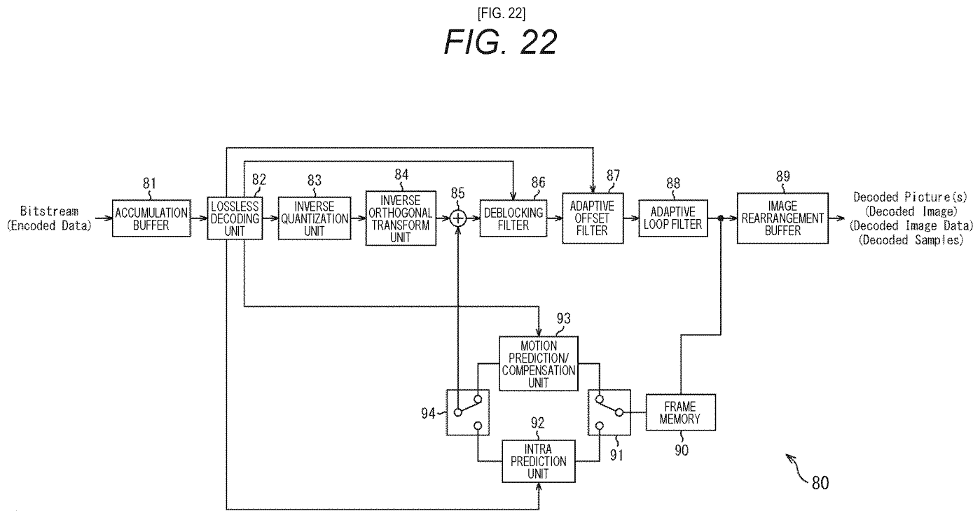

Note that β and Tc, which are parameters of the deblocking filter 71, are extended from β and Tc defined in the HEVC scheme. Each offset of the parameters β and Tc is encoded by the lossless encoding unit 66 as a parameter of the deblocking filter and transmitted to an image decoding apparatus 80 in FIG. 22 described later.

The adaptive offset filter 72 performs offset filter (SAO: Sample adaptive offset) processing for mainly suppressing ringing on the image filtered by the deblocking filter 71.

There are a total of nine types of offset filters including two types of band offsets, six types of edge offsets, and no offset. The adaptive offset filter 72 performs filter processing on the image filtered by the deblocking filter 71 using the quad-tree structure in which the type of offset filter is determined for each divided region and the offset value for each divided region. The adaptive offset filter 72 supplies the image after filter processing to the adaptive loop filter 73.

Note that, in the image encoding apparatus 60, the quad-tree structure and the offset value for each divided region are calculated and used by the adaptive offset filter 72. The calculated quad-tree structure and the offset value for each divided region are encoded by the lossless encoding unit 66 as the adaptive offset parameter and transmitted to the image decoding apparatus 80 in FIG. 22 described later.

The adaptive loop filter 73 performs adaptive loop filter (ALF) processing on the image filtered by the adaptive offset filter 72 for each unit of processing using a filter coefficient. In the adaptive loop filter 73, for example, a two-dimensional Wiener filter is used as the filter. Of course, a filter other than the Wiener filter may be used. The adaptive loop filter 73 supplies the filter processing result to the frame memory 74.

Note that, although not illustrated in the example of FIG. 20, in the image encoding apparatus 60, the filter coefficient is calculated and used by the adaptive loop filter 73 so as to minimize the residual from the original image from the screen rearrangement buffer 61 for each unit of processing. The calculated filter coefficient is encoded by the lossless encoding unit 66 as an adaptive loop filter parameter and transmitted to the image decoding apparatus 80 in FIG. 22 described later.

The frame memory 74 outputs the accumulated reference image to the intra prediction unit 76 or the motion prediction/compensation unit 77 via the selection unit 75 at a predetermined timing.

For example, in the case of an image to which intra encoding is performed, the frame memory 74 supplies the reference image to the intra prediction unit 76 via the selection unit 75. Furthermore, for example, in a case where inter encoding is performed, the frame memory 74 supplies the reference image to the motion prediction/compensation unit 77 via the selection unit 75.

In a case where the reference image supplied from the frame memory 74 is an image to be subjected to intra encoding, the selection unit 75 supplies the reference image to the intra prediction unit 76. Furthermore, in a case where the reference image supplied from the frame memory 74 is an image to be subjected to inter encoding, the selection unit 75 supplies the reference image to the motion prediction/compensation unit 77.

The intra prediction unit 76 performs intra prediction (intra-screen prediction) that generates a predicted image using pixel values in a screen. The intra prediction unit 76 performs intra prediction in a plurality of modes (intra prediction modes).

The intra prediction unit 76 generates predicted images in all intra prediction modes, evaluates each predicted image, and selects an optimum mode. When the optimum intra prediction mode is selected, the intra prediction unit 76 supplies the predicted image generated in the optimum mode to the calculation unit 63 and the calculation unit 70 via the predicted image selection unit 78.

Furthermore, as described above, the intra prediction unit 76 appropriately supplies the parameters such as the intra prediction mode information indicating the adopted intra prediction mode to the lossless encoding unit 66.

The motion prediction/compensation unit 77 performs motion prediction on an image to be subjected to inter encoding, using the input image supplied from the screen rearrangement buffer 61 and the reference image supplied from the frame memory 74 via the selection unit 75. Furthermore, the motion prediction/compensation unit 77 performs motion compensation processing in accordance with a motion vector detected by the motion prediction, and generates a predicted image (inter predicted image information). For example, in a case where sps_ref_pic_resampling_enabled_flag is set to 1, the motion prediction/compensation unit 77 can use a reference frame having a resolution and a chroma format different from those of the current frame.

The motion prediction/compensation unit 77 performs inter prediction processing in all candidate inter prediction modes, and generates a predicted image. The motion prediction/compensation unit 77 supplies the generated predicted image to the calculation unit 63 and the calculation unit 70 via the predicted image selection unit 78. Furthermore, the motion prediction/compensation unit 77 also supplies parameters such as inter prediction mode information indicating the adopted inter prediction mode and motion vector information indicating the calculated motion vector to the lossless encoding unit 66.

The predicted image selection unit 78 supplies the output of the intra prediction unit 76 to the calculation unit 63 and the calculation unit 70 in the case of an image to be subjected to intra encoding, and supplies the output of the motion prediction/compensation unit 77 to the calculation unit 63 and the calculation unit 70 in the case of an image to be subjected to inter encoding.

The rate control unit 79 controls the rate of the quantization operation of the quantization unit 65 so that overflow or underflow does not occur on the basis of the compressed image accumulated in the accumulation buffer 67.

### <Operation of Image Encoding Apparatus>

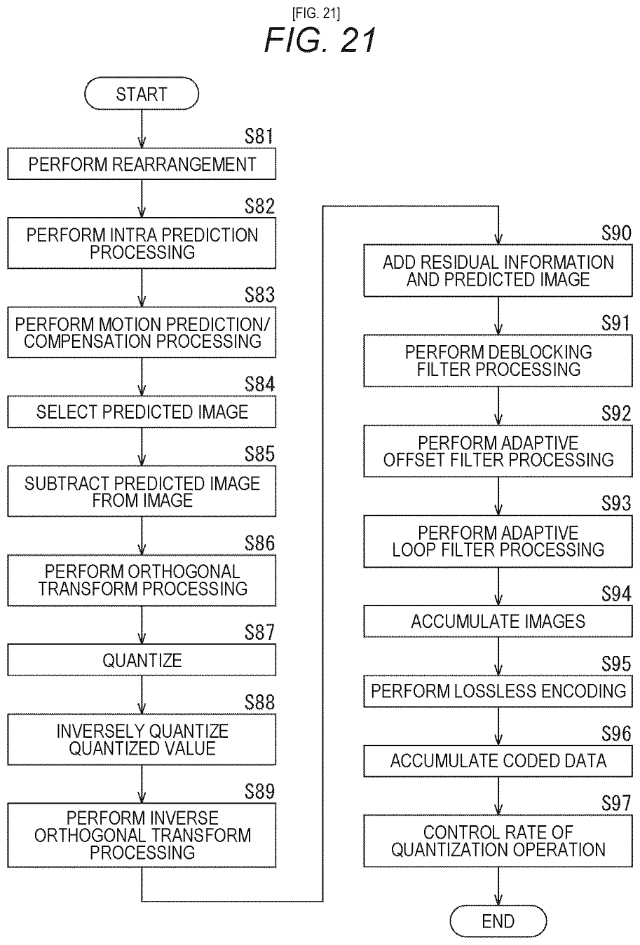

A flow of encoding processing executed by the image encoding apparatus 60 as described above will be described with reference to FIG. 21.

In step S81, the screen rearrangement buffer 61 stores the input image, and performs rearrangement from the display order of each picture to the encoding order.

In a case where the image to be processed supplied from the screen rearrangement buffer 61 is an image of a block to be subjected to intra processing, a decoded image to be referred to is read from the frame memory 74 and supplied to the intra prediction unit 76 via the selection unit 75.

On the basis of these images, in step S82, the intra prediction unit 76 performs intra prediction on the pixels of the block to be processed in all the candidate intra prediction modes. Note that, as the decoded pixel to be referred to, a pixel that is not filtered by the deblocking filter 71 is used.

By this processing, the intra prediction is performed in all the candidate intra prediction modes, and the cost function value is calculated for all the candidate intra prediction modes. Then, the optimum intra prediction mode is selected on the basis of the calculated cost function value, and the predicted image generated by the intra prediction of the optimum intra prediction mode and the cost function value thereof are supplied to the predicted image selection unit 78.

In a case where the image to be processed supplied from the screen rearrangement buffer 61 is an image to be inter-processed, the image to be referred to is read from the frame memory 74 and supplied to the motion prediction/compensation unit 77 via the selection unit 75. In step S83, the motion prediction/compensation unit 77 performs motion prediction/compensation processing on the basis of these images.

Through this process, the motion prediction processing is performed in all the candidate inter prediction modes, the cost function values are calculated for all the candidate inter prediction modes, and the optimum inter prediction mode is determined on the basis of the calculated cost function values. Then, the predicted image generated by the optimum inter prediction mode and the cost function value thereof are supplied to the predicted image selection unit 78.

In step S84, the predicted image selection unit 78 determines one of the optimum intra prediction mode and the optimum inter prediction mode as the optimum prediction mode on the basis of the cost function values output from the intra prediction unit 76 and the motion prediction/compensation unit 77. Then, the predicted image selection unit 78 selects the predicted image in the determined optimum prediction mode, and supplies the predicted image to the calculation units 63 and 70. This predicted image is used for calculation in steps S85 and S90 described later.

Note that the selection information of the predicted image is supplied to the intra prediction unit 76 or the motion prediction/compensation unit 77. In a case where the predicted image in the optimum intra prediction mode is selected, the intra prediction unit 76 supplies information indicating the optimum intra prediction mode (that is, a parameter related to intra prediction) to the lossless encoding unit 66.

In a case where the predicted image in the optimum inter prediction mode is selected, the motion prediction/compensation unit 77 outputs information indicating the optimum inter prediction mode and information (that is, parameters related to motion prediction) corresponding to the optimum inter prediction mode to the lossless encoding unit 66. Examples of the information corresponding to the optimum inter prediction mode include motion vector information and reference frame information.

In step S85, the calculation unit 63 calculates a difference between the image rearranged in step S81 and the predicted image selected in step S84. The predicted images are supplied from the motion prediction/compensation unit 77 in the case of inter prediction and from the intra prediction unit 76 in the case of intra prediction to the calculation unit 63 via the predicted image selection unit 78.

The data amount of the difference data is smaller than that of the original image data. Therefore, it is possible to compress the data amount as compared to a case where the image is directly encoded.

In step S86, the orthogonal transform unit 64 orthogonally transforms the difference information supplied from the calculation unit 63. Specifically, the orthogonal transform such as the discrete cosine transform and the Karhunen-Loeve transform is performed and the transform coefficient is output.

In step S87, the quantization unit 65 quantizes the transform coefficient. At the time of this quantization, the rate is controlled as described in the processing of step S98 described later.

The difference information quantized as described above is locally decoded as follows. That is, in step S88, the inverse quantization unit 68 inversely quantizes the transform coefficient quantized by the quantization unit 65 with a characteristic corresponding to the characteristic of the quantization unit 65. In step S89, the inverse orthogonal transform unit 69 inversely orthogonally transforms the transform coefficient inversely quantized by the inverse quantization unit 68 with a characteristic corresponding to the characteristic of the orthogonal transform unit 64.

In step S90, the calculation unit 70 adds the predicted image input via the predicted image selection unit 78 to the locally decoded difference information to generate a locally decoded (that is, the locally decoded) image (an image corresponding to an input to the calculation unit 63).

In step S91, the deblocking filter 71 performs deblocking filter processing on the image output from the calculation unit 70. At this time, parameters β and Tc extended from β and Tc defined in the HEVC scheme are used as threshold values for determination related to the deblocking filter. The filtered image from the deblocking filter 71 is output to the adaptive offset filter 72.

Note that the respective offsets of the parameters β and Tc input by the user by operating the operation unit and the like and used in the deblocking filter 71 are supplied to the lossless encoding unit 66 as parameters of the deblocking filter.

In step S92, the adaptive offset filter 72 performs adaptive offset filter processing. Through this process, the filter processing is performed on the image filtered by the deblocking filter 71 using the quad-tree structure in which the type of offset filter is determined for each divided region and the offset value for each divided region. The filtered image is supplied to the adaptive loop filter 73.

Note that the determined quad-tree structure and the offset value for each divided region are supplied as adaptive offset parameters to the lossless encoding unit 66.

In step S93, the adaptive loop filter 73 performs adaptive loop filter processing on the image filtered by the adaptive offset filter 72. For example, on the image filtered by the adaptive offset filter 72, the filter processing is performed on the image for each unit of processing using the filter coefficient, and the filter processing result is supplied to the frame memory 74.

In step S94, the frame memory 74 stores the filtered image. Note that an image not filtered by the deblocking filter 71, the adaptive offset filter 72, and the adaptive loop filter 73 is also supplied from the calculation unit 70 and stored in the frame memory 74.

On the other hand, the transform coefficient quantized in step S87 described above is also supplied to the lossless encoding unit 66. In step S95, the lossless encoding unit 66 encodes the quantized transform coefficient output from the quantization unit 65 and the supplied parameters. That is, the difference image is subjected to lossless encoding such as variable-length coding or arithmetic coding, and compressed. Here, examples of the parameters to be encoded include a parameter of the deblocking filter, a parameter of the adaptive offset filter, a parameter of the adaptive loop filter, a quantization parameter, motion vector information, reference frame information, prediction mode information, and the like.

In step S96, the accumulation buffer 67 accumulates the encoded difference image (that is, the encoded stream) as a compressed image. The compressed image accumulated in the accumulation buffer 67 is appropriately read and transmitted to the decoding side via the transmission path.

In step S97, the rate control unit 79 controls the rate of the quantization operation of the quantization unit 65 so that overflow or underflow does not occur on the basis of the compressed image accumulated in the accumulation buffer 67.

When the process of step S97 ends, the encoding processing ends.

### Configuration Example of Image Decoding Apparatus

FIG. 22 illustrates a configuration of an embodiment of an image decoding apparatus as an image processing apparatus to which the present disclosure is applied. The image decoding apparatus 80 illustrated in FIG. 22 is a decoding apparatus corresponding to the image encoding apparatus 60 in FIG. 20.

An encoded stream (encoded data) encoded by the image encoding apparatus 60 is transmitted to the image decoding apparatus 80 corresponding to the image encoding apparatus 60 via a predetermined transmission path, and is decoded.

As illustrated in FIG. 22, the image decoding apparatus 80 includes an accumulation buffer 81, a lossless decoding unit 82, an inverse quantization unit 83, an inverse orthogonal transform unit 84, a calculation unit 85, a deblocking filter 86, an adaptive offset filter 87, an adaptive loop filter 88, a screen rearrangement buffer 89, a frame memory 90, a selection unit 91, an intra prediction unit 92, a motion prediction/compensation unit 93, and a selection unit 94.

The accumulation buffer 81 is also a receiving unit that receives the transmitted coded data. The accumulation buffer 81 receives and accumulates the transmitted coded data. The coded data is encoded by the image encoding apparatus 60. The lossless decoding unit 82 decodes the coded data read from the accumulation buffer 81 at a predetermined timing by a scheme corresponding to the encoding scheme of the lossless encoding unit 66 in FIG. 20.

The lossless decoding unit 82 supplies parameters such as information indicating the decoded intra prediction mode to the intra prediction unit 92, and supplies parameters such as information indicating the inter prediction mode and motion vector information to the motion prediction/compensation unit 93. Furthermore, the lossless decoding unit 82 also supplies the decoded deblocking filter parameters to the deblocking filter 86, and supplies the decoded adaptive offset parameters to the adaptive offset filter 87.

The inverse quantization unit 83 inversely quantizes the coefficient data (quantization coefficient) obtained by decoding by the lossless decoding unit 82 by a scheme corresponding to the quantization scheme of the quantization unit 65 in FIG. 20. That is, the inverse quantization unit 83 inversely quantizes the quantization coefficient by a method similar to the inverse quantization unit 68 in FIG. 20 using the quantization parameter supplied from the image encoding apparatus 60.

The inverse quantization unit 83 supplies the inversely quantized coefficient data, that is, the orthogonal transform coefficient to the inverse orthogonal transform unit 84. The inverse orthogonal transform unit 84 inversely orthogonally transforms the orthogonal transform coefficient by a scheme corresponding to the orthogonal transform scheme of the orthogonal transform unit 64 in FIG. 20, and obtains decoded residual data corresponding to the residual data before being orthogonally transformed by the image encoding apparatus 60.

The decoded residual data obtained by the inverse orthogonal transform is supplied to the calculation unit 85. Furthermore, a predicted image is supplied to the calculation unit 85 from the intra prediction unit 92 or the motion prediction/compensation unit 93 via the selection unit 94.

The calculation unit 85 adds the decoded residual data and the predicted image, and obtains decoded image data corresponding to image data before the predicted image is subtracted by the calculation unit 63 of the image encoding apparatus 60. The calculation unit 85 supplies the decoded image data to the deblocking filter 86.

The deblocking filter 86 appropriately performs deblocking filter processing on the image from the calculation unit 85 to suppress block distortion of the decoded image, and supplies the filter processing result to the adaptive offset filter 87. The deblocking filter 86 is basically configured similarly to the deblocking filter 71 in FIG. 20. That is, the deblocking filter 86 has the parameters β and Tc obtained based on the quantization parameter. The parameters β and Tc are threshold values used for determination related to the deblocking filter.

Note that β and Tc, which are parameters of the deblocking filter 86, are extended from β and Tc defined in the HEVC scheme. Each offset of the parameters β and Tc of the deblocking filter encoded by the image encoding apparatus 60 is received by the image decoding apparatus 80 as a parameter of the deblocking filter, decoded by the lossless decoding unit 82, and used by the deblocking filter 86.

The adaptive offset filter 87 performs offset filter (SAO) processing for mainly suppressing ringing on the image filtered by the deblocking filter 86.

The adaptive offset filter 87 performs filter processing on the image filtered by the deblocking filter 86 using the quad-tree structure in which the type of offset filter is determined for each divided region and the offset value for each divided region. The adaptive offset filter 87 supplies the image after filter processing to the adaptive loop filter 88.

Note that the quad-tree structure and the offset value for each divided region are calculated by the adaptive offset filter 72 of the image encoding apparatus 60, encoded as adaptive offset parameters, and transmitted. Then, the quad-tree structure encoded by the image encoding apparatus 60 and the offset value for each divided region are received as adaptive offset parameters by the image decoding apparatus 80, decoded by the lossless decoding unit 82, and used by the adaptive offset filter 87.

The adaptive loop filter 88 performs filter processing on the image filtered by the adaptive offset filter 87 for each unit of processing by using a filter coefficient, and supplies a filter processing result to the frame memory 90 and the screen rearrangement buffer 89.

Note that, although not illustrated in the example of FIG. 22, in the image decoding apparatus 80, the filter coefficient is calculated for each LUC by the adaptive loop filter 73 of the image encoding apparatus 60, and as the adaptive loop filter parameter, the adaptive loop filter parameter that has been encoded and sent is decoded and used by the lossless decoding unit 82.

The screen rearrangement buffer 89 rearranges the images, and outputs the images (decoded picture(s)) to a display (not illustrated) for display. That is, the order of the frames rearranged for the encoding order by the screen rearrangement buffer 61 of FIG. 20 is rearranged in the original display order. Here, the image output from the screen rearrangement buffer 89 is displayed on a display (not illustrated) after the chroma format is converted into YUV 4:2:0 by the conversion unit 25 in FIG. 13.

The output of the adaptive loop filter 88 is further supplied to the frame memory 90.

The frame memory 90, the selection unit 91, the intra prediction unit 92, the motion prediction/compensation unit 93, and the selection unit 94 correspond to the frame memory 74, the selection unit 75, the intra prediction unit 76, the motion prediction/compensation unit 77, and the predicted image selection unit 78 of the image encoding apparatus 60, respectively.

The selection unit 91 reads the image to be inter-processed and the image to be referred to from the frame memory 90, and supplies the image to the motion prediction/compensation unit 93. Furthermore, the selection unit 91 reads an image to be used for intra prediction from the frame memory 90 and supplies the image to the intra prediction unit 92.

Information indicating the intra prediction mode obtained by decoding the header information and the like are appropriately supplied from the lossless decoding unit 82 to the intra prediction unit 92. On the basis of this information, the intra prediction unit 92 generates a predicted image from the reference image acquired from the frame memory 90, and supplies the generated predicted image to the selection unit 94.

Information (prediction mode information, motion vector information, reference frame information, flag, various parameters, and the like) obtained by decoding the header information is supplied from the lossless decoding unit 82 to the motion prediction/compensation unit 93.

The motion prediction/compensation unit 93 generates a predicted image from the reference image acquired from the frame memory 90 on the basis of the information supplied from the lossless decoding unit 82, and supplies the generated predicted image to the selection unit 94. For example, in a case where sps_ref_pic_resampling_enabled_flag is set to 1, the motion prediction/compensation unit 93 can use a reference frame having a resolution and a chroma format different from those of the current frame.

The selection unit 94 selects the predicted image generated by the motion prediction/compensation unit 93 or the intra prediction unit 92, and supplies the predicted image to the calculation unit 85.

### <Operation of Image Decoding Apparatus>

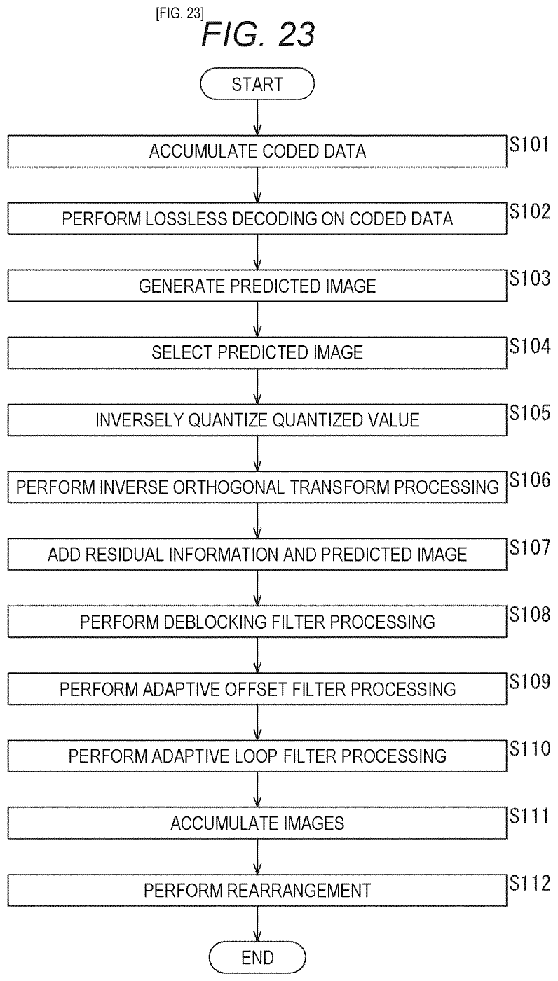

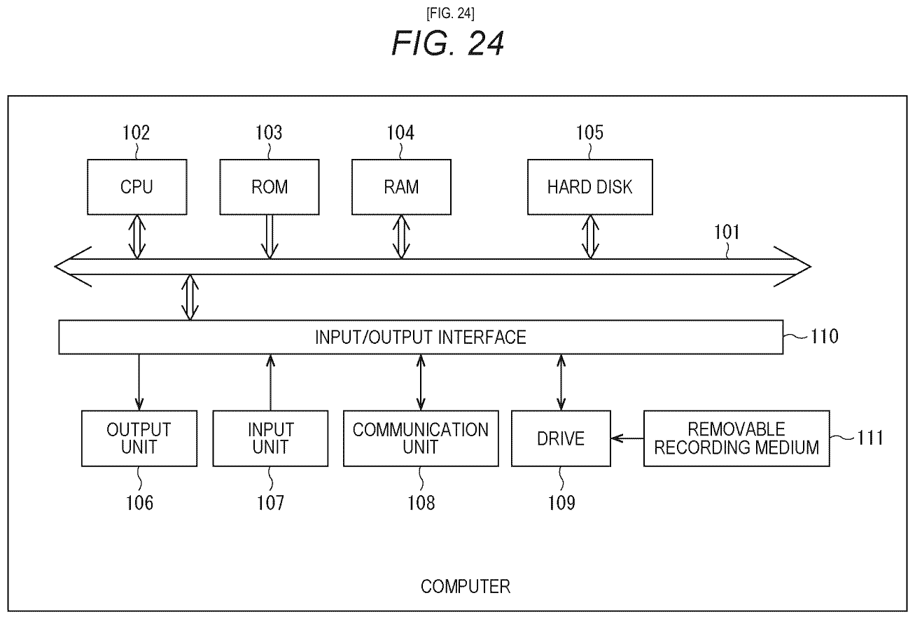

An example of a flow of decoding processing executed by the image decoding apparatus 80 as described above will be described with reference to FIG. 23.

When the decoding processing is started, in step S101, the accumulation buffer 81 receives and accumulates the transmitted encoded stream (data). In step S102, the lossless decoding unit 82 decodes the coded data supplied from the accumulation buffer 81. The I picture, the P picture, and the B picture encoded by the lossless encoding unit 66 in FIG. 20 are decoded.

Prior to picture decoding, parameter information such as motion vector information, reference frame information, and prediction mode information (intra prediction mode or inter prediction mode) is also decoded.

In a case where the prediction mode information is the intra prediction mode information, the prediction mode information is supplied to the intra prediction unit 92. In a case where the prediction mode information is the inter prediction mode information, the prediction mode information, the corresponding motion vector information, and the like are supplied to the motion prediction/compensation unit 93. Furthermore, he parameter of the deblocking filter and the adaptive offset parameter are also decoded and supplied to the deblocking filter 86 and the adaptive offset filter 87, respectively.

In step S103, the intra prediction unit 92 or the motion prediction/compensation unit 93 performs predicted image generation processing in accordance with the prediction mode information supplied from the lossless decoding unit 82.

That is, in a case where the intra prediction mode information is supplied from the lossless decoding unit 82, the intra prediction unit 92 generates an intra predicted image in the intra prediction mode. In a case where the inter prediction mode information is supplied from the lossless decoding unit 82, the motion prediction/compensation unit 93 performs a motion prediction/compensation processing in the inter prediction mode to generate an inter predicted image.

Through this process, the predicted image (intra predicted image) generated by the intra prediction unit 92 or the predicted image (inter predicted image) generated by the motion prediction/compensation unit 93 is supplied to the selection unit 94.

In step S104, the selection unit 94 selects a predicted image. That is, the predicted image generated by the intra prediction unit 92 or the predicted image generated by the motion prediction/compensation unit 93 is supplied. Therefore, the supplied predicted image is selected and supplied to the calculation unit 85, and is added to the output of the inverse orthogonal transform unit 84 in step S107 described later.

In step S102 described above, the transform coefficient decoded by the lossless decoding unit 82 is also supplied to the inverse quantization unit 83. In step S105, the inverse quantization unit 83 inversely quantizes the transform coefficient decoded by the lossless decoding unit 82 with a characteristic corresponding to the characteristic of the quantization unit 65 in FIG. 20.

In step S106, the inverse orthogonal transform unit 84 inversely orthogonally transforms the transform coefficient inversely quantized by the inverse quantization unit 83 with a characteristic corresponding to the characteristic of the orthogonal transform unit 64 in FIG. 20. As a result, the difference information corresponding to the input of the orthogonal transform unit 64 in FIG. 20 (the output of the calculation unit 63) is decoded.

In step S107, the calculation unit 85 adds the predicted image selected in the processing in step S104 described above and input via the selection unit 94 to the difference information. As a result, the original image is decoded.

In step S108, the deblocking filter 86 performs deblocking filter processing on the image output from the calculation unit 85. At this time, parameters β and Tc extended from β and Tc defined in the HEVC scheme are used as threshold values for determination related to the deblocking filter. The filtered image from the deblocking filter 86 is output to the adaptive offset filter 87. Note that, in the deblocking filter processing, the offsets of the parameters β and Tc of the deblocking filter supplied from the lossless decoding unit 82 are also used.

In step S109, the adaptive offset filter 87 performs adaptive offset filter processing. Through this process, the filter processing is performed on the image filtered by the deblocking filter 86 using the quad-tree structure in which the type of offset filter is determined for each divided region and the offset value for each divided region. The filtered image is supplied to the adaptive loop filter 88.

In step S110, the adaptive loop filter 88 performs adaptive loop filter processing on the image filtered by the adaptive offset filter 87. The adaptive loop filter 88 performs filter processing on the input image for each unit of processing by using a filter coefficient calculated for each unit of processing, and supplies a filter processing result to the screen rearrangement buffer 89 and the frame memory 90.

In step S111, the frame memory 90 stores the filtered image.

In step S112, the screen rearrangement buffer 89 rearranges the image after the adaptive loop filter 88. That is, the order of the frames rearranged for encoding by the screen rearrangement buffer 61 of the image encoding apparatus 60 is rearranged to the original display order. Thereafter, the image rearranged by the screen rearrangement buffer 89 is output to a display (not illustrated), and the image is displayed.

When the process of step S112 ends, the decoding processing ends.

### Configuration Example of Computer

Next, a series of processing (image processing method) described above can be performed by hardware or by software. In a case where the series of processing is performed by the software, a program configuring the software is installed on a general-purpose computer, and the like.

FIG. 23 is a block diagram illustrating a configuration example of an embodiment of a computer on which a program for executing the series of processing described above is installed.

The program can be recorded in advance on a hard disk 105 or ROM 103 as a recording medium incorporated in the computer.

Alternatively, further, the program can also be stored (recorded) in a removable recording medium 111 driven by a drive 109. Such a removable recording medium 111 can be provided as so-called package software. Here, examples of the removable recording medium 111 include, for example, a flexible disk, a compact disc read only memory (CD-ROM), a magneto optical (MO) disk, a digital versatile disc (DVD), a magnetic disk, a semiconductor memory, and the like.

Note that, in addition to installing the program on the computer from the removable recording medium 111 as described above, the program can be downloaded to the computer through a communication network or a broadcasting network and installed on the hard disk 105 to be incorporated. In other words, for example, the program can be wirelessly transferred from a download site to the computer through an artificial satellite for digital satellite broadcasting, or can be transferred by a wire to the computer through a network such as a local area network (LAN) and the Internet.

The computer has a built-in central processing unit (CPU) 102, and an input/output interface 110 is connected to the CPU 102 through a bus 101.

Upon receiving a command input by the user, for example, by operating the input unit 107 through the input/output interface 110, the CPU 102 executes a program stored in the read only memory (ROM) 103 accordingly. Alternatively, the CPU 102 loads a program stored in the hard disk 105 into a random access memory (RAM) 104 to execute the program.

Therefore, the CPU 102 performs a process according to the flowchart described above or a process to be performed according to a configuration in the block diagram described above. Then, as necessary, the CPU 102 outputs a processing result from an output unit 106, or transmits the processing result from a communication unit 108, and further, causes the hard disk 105 to record the processing result, and the like, through the input/output interface 110, for example.

Note that, the input unit 107 includes a keyboard, a mouse, a microphone, and the like. Furthermore, the output unit 106 includes a liquid crystal display (LCD), a speaker, and the like.

Here, in the present specification, the processing to be performed by the computer in accordance with the program is not necessarily performed in time series according to orders described in the flowcharts. That is, the processing to be performed by the computer in accordance with the program includes processing to be executed in parallel or independently of one another (parallel processing or object-based processing, for example).

Furthermore, the program may be processed by one computer (one processor) or processed in a distributed manner by a plurality of computers. Moreover, the program may be transferred to a distant computer to be executed.

Moreover, in the present specification, a system means a set of a plurality of components (apparatuses, modules (parts), and the like), and it does not matter whether or not all the components are in the same housing. Therefore, a plurality of apparatuses housed in separate housings and connected to each other via a network and one apparatus in which a plurality of modules is housed in one housing are both systems.

Furthermore, for example, a configuration described as one apparatus (or one processing unit) may be divided and configured as the plurality of the apparatuses (or the processing units). Conversely, configurations described above as a plurality of apparatuses (or processing units) may be collectively configured as one apparatus (or processing unit). Furthermore, it goes without saying that a configuration other than the above-described configurations may be added to the configuration of each apparatus (or each processing unit). Moreover, if the configuration and operation of the entire system are substantially the same, a part of the configuration of a certain apparatus (or processing unit) may be included in the configuration of another apparatus (or another processing unit).

Furthermore, for example, the present technology can be configured as cloud computing in which one function is shared and jointly processed by the plurality of the apparatuses through the network.

Furthermore, for example, the program described above can be executed by any apparatus. In this case, the apparatus is only required to have a necessary function (functional block and the like) and obtain necessary information.

Furthermore, for example, each step described in the flowcharts described above can be executed by one apparatus, or can be executed in a shared manner by the plurality of the apparatuses. Moreover, in a case where a plurality of processes is included in one step, the plurality of processes included in the one step can be executed by one apparatus or shared and executed by the plurality of the apparatuses. In other words, the plurality of processes included in one step can also be executed as processes of a plurality of steps.

Conversely, the processes described as the plurality of the steps can also be collectively executed as one step.

Note that, in the program to be executed by the computer, the processes in steps describing the program may be executed in time series in the order described in the present specification, or may be executed in parallel, or independently at a necessary timing such as when a call is made. That is, unless there is a contradiction, the process in each step may also be executed in an order different from the orders described above. Moreover, the processes in the steps describing the program may be executed in parallel with processes of another program, or may be executed in combination with processes of the other program.

Note that, a plurality of the present technologies that has been described in the present specification can each be implemented independently as a single unit unless there is a contradiction. Of course, a plurality of arbitrary present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

### Combination Examples of Configurations

Note that the present technology can also have the following configurations.

(1)

An image processing apparatus including:
a conversion unit that performs reduction processing of reducing resolution of at least a luminance component of an image including the luminance component and two chrominance components to convert a chroma format of the image; and
an encoding unit that encodes the image in which the chroma format has been converted to generate a bitstream.

(2)

The image processing apparatus according to (1),
in which the conversion unit does not perform reduction on the chrominance components or performs reduction on the chrominance components at a reduction ratio equal to or less than a reduction ratio of the luminance component, and converts the chroma format of the image.

(3)

The image processing apparatus according to (1) or (2),
in which in a case where the chroma format of the image original is YUV 4:2:0 or YUV 4:2:2, the conversion unit converts the chroma format of the image into YUV 4:4:4.

(4)

The image processing apparatus according to any one of (1) to (3), further including:
a control unit that controls a set of flags indicating whether or not it is effective to convert the chroma format of the image in a middle of the bitstream.

(5)

The image processing apparatus according to (4),
in which in a case where it is effective to convert the chroma format of the image in the middle of the bitstream, the control unit controls a parameter for specifying the chroma format for each picture of the image.

(6)

An image processing method including:
by an image processing apparatus,
performing reduction processing of reducing resolution of at least a luminance component of an image including the luminance component and two chrominance components to convert a chroma format of the image; and
encoding the image in which the chroma format has been converted to generate a bitstream.

(7)

An image processing apparatus including:
a decoding unit that decodes a bitstream to generate an image including one luminance component and two chrominance components; and
a conversion unit that converts a chroma format of the image by performing enlargement processing of enlarging resolution of at least the luminance component of the image generated by the decoding unit.

(8)

The image processing apparatus according to (7),
in which the conversion unit does not perform enlargement on the chrominance components or performs enlargement on the chrominance components at an enlargement ratio equal to or less than an enlargement ratio of the luminance component to convert the chroma format of the image.

(9)

The image processing apparatus according to (7),
in which in a case where the chroma format of the image is YUV 4:4:4, the conversion unit converts the chroma format of the image into YUV 4:2:0 or YUV 4:2:2.

(10)

The image processing apparatus according to any one of (7) to (9), further including:
a control unit that controls conversion of the chroma format of the image by the conversion unit according to a flag indicating whether or not it is effective to perform conversion of the chroma format of the image in a middle of the bitstream.

(11)

The image processing apparatus according to (10),
in which in a case where it is effective to convert the chroma format of the image in the middle of the bitstream, the control unit controls conversion of the chroma format of the image by the conversion unit on the basis of a parameter for specifying the chroma format for each picture of the image.

(12)

The image processing apparatus according to (11),
in which the control unit derives the resolution of the image of the chrominance components in a current frame according to the resolution and the chroma format of the image of the luminance component in the current frame, and determines whether or not resolution of a reference frame is larger than the resolution of the current frame, and
in a case where it is determined that the resolution of the reference frame is higher than the resolution of the current frame, the decoding unit reduces the reference frame in accordance with the resolution of the current frame and performs inter prediction to decode the bitstream.

(13)

The image processing apparatus according to (12),
in which in a case where it is determined that the resolution of the reference frame is smaller than the resolution of the current frame, the decoding unit enlarges the reference frame in accordance with the resolution of the current frame and performs inter prediction to decode the bitstream.

(14)

An image processing method including:
by an image processing apparatus,
decoding a bitstream to generate an image including one luminance component and two chrominance components; and
converting a chroma format of the image by performing enlargement processing of enlarging resolution of at least the luminance component of the image generated.

Note that, the present embodiment is not limited to the embodiment described above, and various modifications can be made without departing from the gist of the present disclosure. Furthermore, the effects described in the present specification are merely examples and are not limited, and other effects may be provided.

### REFERENCE SIGNS LIST

11 Image processing system
12 Image encoding apparatus
13 Image decoding apparatus
21 Conversion unit
22 Encoding unit
23 Control unit
24 Decoding unit
25 Conversion unit
26 Control unit

1. An image processing apparatus comprising:
a conversion unit that performs reduction processing of reducing resolution of at least a luminance component of an image including the luminance component and two chrominance components to convert a chroma format of the image; and
an encoding unit that encodes the image in which the chroma format has been converted to generate a bitstream.

2. The image processing apparatus according to claim 1,
wherein the conversion unit does not perform reduction on the chrominance components or performs reduction on the chrominance components at a reduction ratio equal to or less than a reduction ratio of the luminance component, and converts the chroma format of the image.

3. The image processing apparatus according to claim 1,
wherein in a case where the chroma format of the image original is YUV 4:2:0 or YUV 4:2:2, the conversion unit converts the chroma format of the image into YUV 4:4:4.

4. The image processing apparatus according to claim 1, further comprising:
a control unit that controls a set of flags indicating whether or not it is effective to convert the chroma format of the image in a middle of the bitstream.

5. The image processing apparatus according to claim 4,
wherein in a case where it is effective to convert the chroma format of the image in the middle of the bitstream, the control unit controls a parameter for specifying the chroma format for each picture of the image.

6. An image processing method comprising:
by an image processing apparatus,
performing reduction processing of reducing resolution of at least a luminance component of an image including the luminance component and two chrominance components to convert a chroma format of the image; and
encoding the image in which the chroma format has been converted to generate a bitstream.

7. An image processing apparatus comprising:
a decoding unit that decodes a bitstream to generate an image including one luminance component and two chrominance components; and
a conversion unit that converts a chroma format of the image by performing enlargement processing of enlarging resolution of at least the luminance component of the image generated by the decoding unit.

8. The image processing apparatus according to claim 7,
wherein the conversion unit does not perform enlargement on the chrominance components or performs enlargement on the chrominance components at an enlargement ratio equal to or less than an enlargement ratio of the luminance component to convert the chroma format of the image.

9. The image processing apparatus according to claim 7,
wherein in a case where the chroma format of the image is YUV 4:4:4, the conversion unit converts the chroma format of the image into YUV 4:2:0 or YUV 4:2:2.

10. The image processing apparatus according to claim 7, further comprising:
a control unit that controls conversion of the chroma format of the image by the conversion unit according to a flag indicating whether or not it is effective to perform conversion of the chroma format of the image in a middle of the bitstream.

11. The image processing apparatus according to claim 10,
wherein in a case where it is effective to convert the chroma format of the image in the middle of the bitstream, the control unit controls conversion of the chroma format of the image by the conversion unit on a basis of a parameter for specifying the chroma format for each picture of the image.

12. The image processing apparatus according to claim 11,
wherein the control unit derives the resolution of the image of the chrominance components in a current frame according to the resolution and the chroma format of the image of the luminance component in the current frame, and determines whether or not resolution of a reference frame is larger than the resolution of the current frame, and
in a case where it is determined that the resolution of the reference frame is higher than the resolution of the current frame, the decoding unit reduces the reference frame in accordance with the resolution of the current frame and performs inter prediction to decode the bitstream.

13. The image processing apparatus according to claim 12,
wherein in a case where it is determined that the resolution of the reference frame is smaller than the resolution of the current frame, the decoding unit enlarges the reference frame in accordance with the resolution of the current frame and performs inter prediction to decode the bitstream.

14. An image processing method comprising:
by an image processing apparatus,
decoding a bitstream to generate an image including one luminance component and two chrominance components; and
converting a chroma format of the image by performing enlargement processing of enlarging resolution of at least the luminance component of the image generated.
